(19) United States
(12) Patent Application Publication
(10) Pub. No.: US 2016/0307286 A1
(43) Pub. Date: Oct. 20, 2016

(54) Safety Communication Hub for Organizations

(71) Applicant: ATHOC, Inc., San Mateo, CA (US)

(72) Inventors: Guy Miasnik, Mountain View, CA (US); Aviv Siegel, San Mateo, CA (US); Itzhak Ziv, Boulder, CO (US); Ramon Jacinto Pinero, San Jose, CA (US); Joseph C. Ng, San Mateo, CA (US); Oded Yehuda Shekel, Sunnyvale, CA (US)

(73) Assignee: ATHOC, Inc., San Mateo, CA (US)

(21) Appl. No.: 14/687,788

(22) Filed: Apr. 15, 2015

(51) Int. Cl. G06Q 50/26; H04L 12/58; H04L 29/08; H04L 29/06

(52) U.S. Cl. CPC G06Q 50/265; H04L 65/403; H04L 51/04; H04L 67/10

(57) ABSTRACT

In order to improve communication and coordination among organizations, an information-management system conducts managed communication (including tracked delivery and duplication avoidance) with information systems, information sources and electronic devices used by organizations. In particular, in response to a message about a current or potentially imminent event (such as an emergency or a crisis situation), the information-management system generates an inter-organization message about the event based on information-sharing rules of at least an organization in the organizations that specify sharable information across the organizations and non-sharable information across the organizations. These inter-organization messages include the sharable information and generalized information corresponding to the non-sharable information to control distribution across the organizations of information about: the organizations, members of the organizations, and/or the event. Moreover, the information-management system communicates the inter-organization message with at least another organization in the organizations based on interrelationship information that specify interrelationships among the organizations.

### BACKGROUND

1. Field

The described embodiments relate to techniques for exchanging information. More specifically, the described embodiments relate to techniques for exchanging information associated with events among organizations.

2. Related Art

In order to respond effectively to natural and man-made emergencies, organizations (e.g., governmental agencies) typically need to share information, such as: descriptions of potential and actual threats and incidents as they occur and evolve, updates about the status of events, response-coordination information, warnings, instructions and/or requests for additional information or assistance. Because of the wide range of types of organizations, establishing and maintaining such communication and interoperability usually involves: constant assessment, establishing and improving the communication, mutual support agreements, and/or policies, procedures and tools that enable timely and appropriate action by the participating organizations.

However, in the aftermath of recent tragic events (such as fatal shootings at governmental facilities), shortfalls were identified in existing communication systems that adversely affected the ability of organizations to share information, and to collaborate and coordinate activities across organizations at the operational and tactical levels when responding to significant crises. For example, using existing communication systems it can be difficult to maintain continuous communication capabilities with multiple organizations, which may geographically distributed over a large area or region. Furthermore, it is also challenging to simultaneously update the multiple organizations and to provide them actionable information so that their efforts can be coordinated while also avoiding communication of private or privileged information (which is sometimes referred to as ‘personally identifiable information’ or PII), which may be protected by organizational policies, laws and regulations. These difficulties often result in longer response times and potentially ill-informed decisions from on-scene leaders and commanders.

### SUMMARY

The described embodiments relate to an information-management system. This information-management system includes an interface mechanism that communicates with information systems, information sources and electronic devices used by organizations, where the organizations are enrolled in a service provided by the information-management system. Moreover, the information-management system includes a control mechanism that receives, from at least one of the information systems and the information sources, a message associated with an event. Furthermore, the control mechanism generates an inter-organization message about the event based on information-sharing rules of at least an organization in the organizations that specify sharable information across the organizations and non-sharable information across the organizations, where the inter-organization messages include the sharable information and generalized information corresponding to the non-sharable information to control distribution across the organizations of information about: the organizations, members of the organizations, and/or the event. Additionally, the control mechanism communicates the inter-organization message with at least another organization in the organizations based on interrelationship information, where the other organization is different from the organization, and the interrelationship information specifies interrelationships among the organizations.

Note that the event may include: an emergency, and/or a crisis situation.

Moreover, the organizations may include: first groups in an entity, second groups at geographic locations associated with the entity, state governments in the entity, local governments in the entity, government agencies, commercial entities, non-government organizations, and/or healthcare organizations.

Furthermore, the communication may be bi-directional, may include structured and non-structured responses, and may be managed based on the interrelationship information.

Additionally, the inter-organization messages may be: processed in an order that is determined based on priorities associated with the inter-organization messages; and/or communicated based on a hierarchy specified by the interrelationship information.

In some embodiments, the non-sharable information is not excluded from the inter-organization messages.

Moreover, the control mechanism may register a new organization that is different from the organizations. During or after the registration, the control mechanism may: determine the information-sharing rules for the new organization based on characteristics associated with the new organization; and/or receive the information-sharing rules from the new organization. Furthermore, during or after the registration, the control mechanism may create agreements specifying the information-sharing rules among pairwise combinations of the new organization and the organizations based on the characteristics of the new organization and characteristics of the organizations. Additionally, the control mechanism may discover an additional organization based on the agreements and the characteristics, and may recommend the additional organization to the new organization for inclusion in the organizations.

In some embodiments, the control mechanism determines the interrelationship information based on: communication among the organizations; analysis of characteristics of the organizations; and/or feedback about candidate interrelationship information received from the organizations.

Note that the inter-organization messages may include duplication-avoidance features to prevent information loops among the organizations when the inter-organization messages are communicated among the organizations. During an information loop, a source and/or an intermediary recipient of an inter-organization message may receive the inter-organization message more than once.

Moreover, the control mechanism may: receive a subsequent inter-organization message; analyze the subsequent inter-organization message; and add, to the subsequent inter-organization message, a link with a history of an associated thread in the inter-organization messages.

Furthermore, the control mechanism may: track delivery of the inter-organization messages; and provide a notification when a delivery failure occurs.

Additionally, the control mechanism may: identify a new organization to add to the organizations during the event based on a type of the event and/or a type of the new organization; and specify the information-sharing rules for the new organization. Note that specifying the information-sharing rules may involve: using default information-sharing rules; determining the information-sharing rules; and/or providing recommended information-sharing rules.

In some embodiments, the control mechanism includes: a processor coupled to the interface mechanism; and a memory, coupled to the processor, that stores a program module which is executed by the processor. The program module may include instructions for at least some of the operations performed by the control mechanism.

Another embodiment provides a computer-program product for use with the information-management system. This computer-program product includes instructions for at least some of the operations performed by the information-management system.

Another embodiment provides a method for communicating the inter-organization message among the organizations that are enrolled in the service provided by the information-management system, which may be performed by an embodiment of the information-management system. During operation, the information-management system receives, from an information system and/or an information source, the message associated with the event. Then, using the control mechanism, the information-management system generates the inter-organization message about the event based on the information-sharing rules of at least the organization in the organizations that specify the sharable information across the organizations and the non-sharable information across the organizations, where the inter-organization messages include the sharable information and the generalized information corresponding to the non-sharable information to control distribution across the organizations of information about: the organization, members of the organization, and/or the event. Next, the information-management system communicates the inter-organization message with at least the other organization in the organizations based on interrelationship information, where the other organization is different from the organization, and the interrelationship information specifies interrelationships among the organizations.

Another embodiment provides an information-management system that allows the organizations to communicate the inter-organization messages with organizations that are protected by firewalls (such as non-public computer systems). In particular, the inter-organization messages may be compliant with an interface requirement of a protected organization protected by a firewall so the inter-organization messages pass through the firewall unimpeded. The protected organization may maintain an open connection with information-management system.

Another embodiment provides an information-management system in which moderator determines: which organizations can join a community; which of the organizations communicate with each other; and/or the information-sharing rules for the organizations.

Another embodiment provides an information-management system that communicates the inter-organization message among the organizations. These inter-organization messages may not be associated with individuals. Instead, the information communicated via the inter-organization messages may be associated with electronic devices (such as fire alarms or cybersecurity detectors) that collect data.

Another embodiment provides an information-management system that communicates healthcare information. In particular, the information-sharing rules may allow the organizations to exchange the inter-organization messages while complying with regulations (such as the Health Insurance Portability Accountability Act) by de-identifying and generalizing protected health information in the inter-organization messages.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating communication in an information-management system in accordance with an embodiment of the present disclosure.

FIG. 2 is a block diagram illustrating the information-management system of FIG. 1 in accordance with an embodiment of the present disclosure.

FIG. 3 is a block diagram illustrating the information-management system of FIG. 1 in accordance with an embodiment of the present disclosure.

FIG. 4 is a block diagram illustrating the information-management system of FIG. 1 in accordance with an embodiment of the present disclosure.

FIG. 5 is a flow diagram illustrating a method for communicating an inter-organization message among organizations that are enrolled in a service provided by the information-management system of FIG. 1 in accordance with an embodiment of the present disclosure.

FIG. 6 is a flow diagram illustrating communication in the information-management system of FIG. 1 in accordance with an embodiment of the present disclosure.

FIG. 7 is a flow diagram illustrating a method for registering an organization in the information-management system of FIG. 1 in accordance with an embodiment of the present disclosure.

FIG. 8 is a flow diagram illustrating a method for establishing cross-organization agreements in the information-management system of FIG. 1 in accordance with an embodiment of the present disclosure.

FIG. 9 is a flow diagram illustrating a method for modifying or cancelling cross-organization agreements in the information-management system of FIG. 1 in accordance with an embodiment of the present disclosure.

FIG. 10 is a flow diagram illustrating a method for communicating targeted notifications in the information-management system of FIG. 1 in accordance with an embodiment of the present disclosure.

FIG. 11 is a flow diagram illustrating a method for sharing information in the information-management system of FIG. 1 using a publish/subscribe technique in accordance with an embodiment of the present disclosure.

FIG. 12 is a block diagram illustrating a computer system in the information-management system of FIG. 1 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to improve communication and coordination among organizations, an information-management system (which is sometimes referred to as a ‘safety communication hub’) conducts managed communication (including tracked delivery, delivery-scope control and duplication avoidance) with information systems, information sources and electronic devices used by organizations. In particular, in response to a message about a current or potentially imminent event (such as an emergency or a crisis situation), the information-management system generates an inter-organization message about the event based on information-sharing rules of at least an organization in the organizations that specify sharable information across the organizations and non-sharable information across the organizations. These inter-organization messages include the sharable information and generalized information corresponding to the non-sharable information to control distribution across the organizations of information about: the organizations, members of the organizations, and/or the event. Moreover, the information-management system communicates the inter-organization message with at least another organization in the organizations based on interrelationship information that specify interrelationships among the organizations.

In this way, the information-management system may allow multiple levels in the organizations (such as governments and/or governmental agencies) to share information (such as: alerts, Requests for Information or RFIs, warnings, updates, situational awareness, notifications, reports, collaborative response decision-making and/or other type of information) across or among the organizations while protecting private or privileged information, i.e., the non-sharable information. Moreover, the originating organization may include indication of classification, sensitivity and/or allowed scope of information to prevent distribution outside of the allowed scope. Alternatively or additionally, the originating organization may specify forwarding constraints, such as that information is not to be forwarded outside government organization, and/or outside of geo-political boundaries. This effective, safety-related communication may enable predictable and timely receipt and dissemination of the information, as well as appropriate and coordinated responses to the distributed information. Furthermore, the interoperability and access to shared services provided by the information-management system may improve mission success (e.g., via reduced response times and better-informed decisions), minimize complexity and reduce duplication of ongoing efforts by the organizations. Consequently, the information-management system may address the problems associated with existing communication techniques and, thus, may help on-scene leaders and commanders save lives.

In the discussion that follows, organizations should be understood to include: groups in an entity (such as different departments in a company, a municipality or a law-enforcement agency, different agencies in a government, different cities in a state), groups at geographic locations associated with the entity (such as different military installations, different cities in a state, different industrial facilities, etc.), state governments in the entity (such as states in a country), local governments in the entity (such as different counties in a state), government agencies (such as different branches of the military, different emergency-response agencies or services), commercial entities (such as different companies), and/or healthcare organizations (such as different hospitals). More general, organizations include: multiple individuals, may have one or more types (such as corporations, governmental agencies, universities, etc.), and/or may be located in one or more regions or countries. For example, the organization types may include: an information source or publisher of content (such as the National Weather Service or a provider of social media via a social network), a consumer of the content (such as a business located at an airport) and/or a collaborator (such as the Transportation Security Agency).

Note that the organizations may be consumers of information processed by the information-management system. As described further below, the organizations may receive information, provide information and/or may engage in bidirectional communication. Furthermore, the organizations may be arranged in a hierarchy (such as a chain of command in the military or in the government, or based on their locations relative to the event) or may be related to a virtual hierarchy, such as a community of organizations related to emergency management and response around a geographic region (e.g., a county) or a facility (e.g., an airport or seaport).

The information communicated by the information-management system may originate from a variety of sources, including: the participating organizations, and/or public, government and commercial content sources (which may include social media). In general, the information may be communicated using public and/or private networks, such as: a wireless local area network, an intranet, the Internet, and/or cellular-telephone networks. Furthermore, the information may be communicated in packets or frames having a variety of different formats and/or packets or frames that are compatible with a variety of different communication protocols or standards. For example, packets with the information may be transmitted and received by radios in electronic devices in the information-management system in accordance with a communication protocol, such as: an Institute of Electrical and Electronics Engineers (IEEE) 802.11 standard or Wi-Fi® (from the Wi-Fi Alliance of Austin, Tex.), Bluetooth® (from the Bluetooth Special Interest Group of Kirkland, Wash.), a cellular-telephone communication protocol and/or another type of wireless interface.

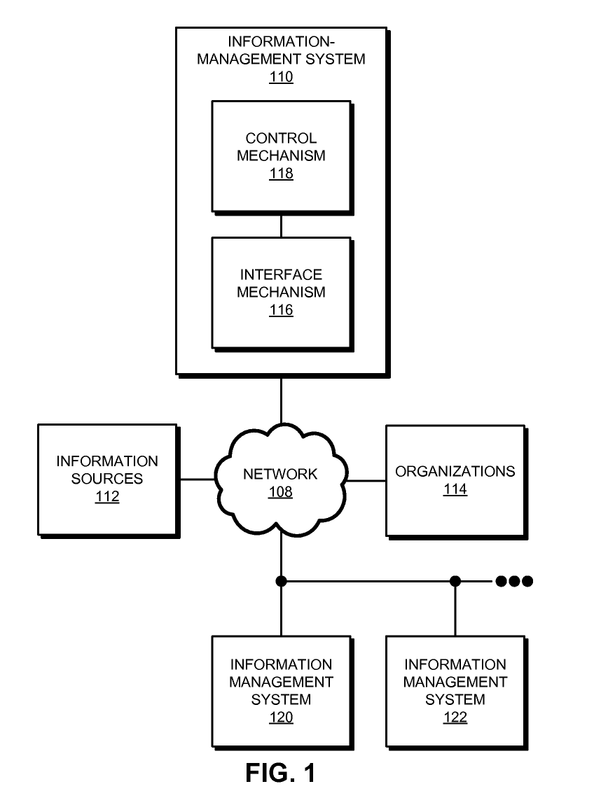

We describe embodiments of the information-management system. FIG. 1 presents a block diagram illustrating communication in an information-management system 110. This information-management system communicates, via one or more networks (such as network 108, e.g., the Internet and/or intranets), with information sources 112 (such as information-publishing systems and/or servers) and computer systems and electronic devices (such as information systems or crisis-management systems) associated with (i.e., operated by or on behalf of) organizations 114 that enroll in a service provided by information-management system 110. For example, information sources 112 may include: the National Weather Service, the Integrated Public Alert and Warning System, the United States Geological Survey, social media, news media, etc. These information sources may provide structured information in messages about: the risk of an event (or incident), the occurrence of the event, and/or the aftermath or updates related to the event. In some embodiments, at least some of information sources 112 are included in or associated with one or more of organizations 114.

Before, during or after an event or an incident (such as an emergency or a crisis situation, although the event may or may not involve an emergency), information-management system 110 may manage the exchange of information among information sources 112 and multiple levels of organizations 114. For example, information-management system 110 may facilitate communication of: alerts, RFIs, warnings, notifications, situational awareness updates, sensor-system data (such as data associated with cellular telephones or other electronic devices used by particular individuals and/or data associated with physical security systems, fire alarms, cybersecurity systems, etc.), reports and responses, decisions of incident commanders, event data, location data, control data and other types of information (which are sometimes collectively referred to as ‘information’). Moreover, information-management system 110 may allow organizations 114 to exchange information to enable timely and appropriate crisis-related preparedness, response and follow-up to the event. In general, the communication conveyed using information-management system 110 may be: tracked, threaded (so that particular conversations or exchanges can be identified and followed), multi-directional, and/or structured (such as information having a predefined format, e.g., via a form). In order to facilitate the communication, information-management system 110 may maintain a repository (such as one or more data structures stored in a computer-readable memory) with contacts at organizations 114, which are continuously maintained by authorized representatives of organizations 114. This management of information exchange may be occur without compromising the security of private networks of organizations 114, such as those having data protected by firewalls (thus, information-management system 110 may communicate with computer systems and electronic devices that are or that are not protected by firewalls, such as those that are not accessible via public networks like the Internet).

One challenge associated with inter-organization communication is protecting privileged, confidential or sensitive information (such as PII) of organizations 114. In order to systematically protect such information, information-management system 110 may store agreements between at least pairs of organizations 114 that specify rules for types of information that can be disseminated and received. In particular, the agreements may include information-sharing rules that specify sharable information and non-sharable information. In some embodiments, information-management system 110 assists organizations 114 by determining the agreements, e.g., based on business rules (or logic) and/or characteristics of organizations 114.

Then, based on the information-sharing rules, information-management system 110 may generate inter-organization messages that protect the non-sharable information. In particular, information-management system 110 may generalize the non-sharable information (as opposed to filtering out or excluding the non-sharable information), so that organizations 114 still receive the information they need to understand, coordinate and appropriately respond to the event. In the discussion that follows, ‘generalizing’ non-sharable information may include broadening or abstracting the non-sharable information so that information that is not to be shared is obfuscated in a way that cannot (or is extremely difficult) to reverse. For example, the source of the non-sharable information (such as an organization that reports a cyber-security breach) may be generalized. Therefore, while the identification of the source may be known to immediate destination recipients, the organization may wish to share the information (‘we had a cyber-security incident where XYZ took place’) but may not want the details of where it happened to be disclosed outside the closed circle to prevent potential commercial and liability impact. In some cases, an organization may want to submit the incident anonymously, which is also a case of generalization of the non-shareable information (i.e., the source of report).

Note that information-management system 110 may ‘generalize’ specific non-sharable information in an original message based on the particular information-sharing rules among the originating and receiving organizations, which determine which elements and/or attributes of the original message may or not be shared and with whom. Consequently, there may be more than one resulting inter-organization message generated and communicated to different recipients for each original message. In general, the non-sharable information may not be excluded from the inter-organization messages. Moreover, information-management system 110 may apply the information-sharing rules automatically to generate and distribute inter-organization messages with generalized non-sharable information (e.g., substitution of elements tagged as protected health information) or semi-automatically (e.g., by recommending a generalized inter-organization message to an operator prior to distribution).

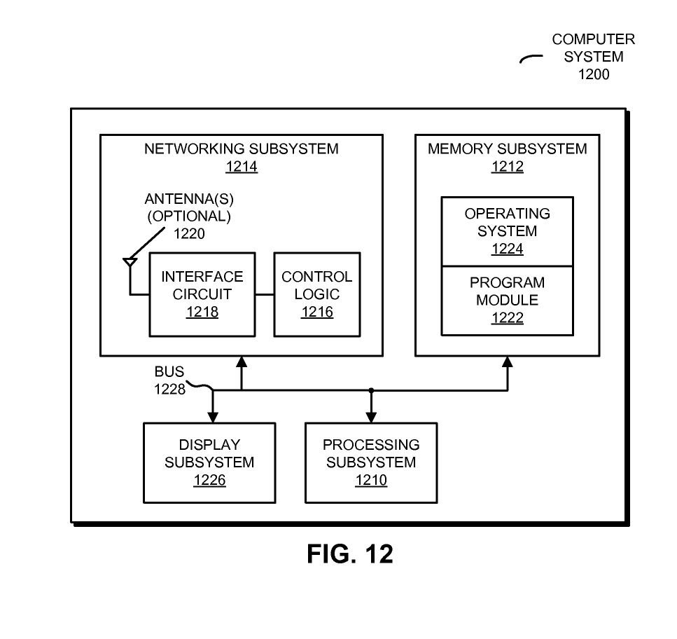

As shown in FIG. 1, information-management system 110 may include an interface mechanism 116 that communicates with information sources 112 and computer systems and electronic devices associated with organizations 114. Moreover, information-management system 110 may include a control mechanism 118 that receives, from at least one of information sources 112 and organizations 114 a message associated with the event. For example, the message may indicate that there is a risk for extreme weather (such as a tornado, which is an illustration of an event that has not occurred yet). Alternatively, the message may indicate there has been an earthquake or that there is a shooting at a facility (which are illustrations of events that have already occurred or that are ongoing). Thus, the event may include an emergency (or a crisis), or may not be an emergency. As described further below with reference to FIG. 12, information-management system 110 may include subsystems, such as a networking subsystem (which is an illustration of interface mechanism 116), a memory subsystem (which stores information used by information-management system 110, such as attributes or characteristics, business rules, shared-information rules, agreements, contacts at organizations 114, etc.) and a processor subsystem (which is an illustration of control mechanism 118).

Furthermore, control mechanism 118 may generate inter-organization messages about the event based on information-sharing rules of at least an organization in organizations 114 that specify sharable information across organizations 114 and non-sharable information across organizations 114, where the inter-organization messages include the sharable information and generalized information corresponding to (e.g., related to or a function of) the non-sharable information to control distribution across organizations 114 of information about: organizations 114, members of organizations 114, and/or the event.

For example, the non-sharable information may include specified identities of members of the organization. During a shooting incident (the event) in which there are individuals who are in danger at a specific location (such as a building at a facility), the inter-organization messages may alert one or more other organizations about the event so that they can increase security or take appropriate protective measures to secure their facilities and protect their personnel. These inter-organization messages may include specific information about the location of the event and the potentially affected members of the organization without disclosing PII, so that the one or more other organizations have the information they need to understand the type of event and its scope. In particular, as an illustration of the generalized information, the inter-organization messages may assign random identifiers to the potentially affected members of the organization, such as victim A, hostage B, etc. Additional inter-organization messages to the one or more other organizations may request mutual aid to deal with casualties. These inter-organization messages may exclude the specific identities of the injured personnel. Instead, the inter-organization messages may include a count of the number of casualties and their condition, which is generalized information that provides the one or more other organizations the information they need to respond appropriately to the request from the organization. Thus, in some embodiments, the non-sharable information is not simply excluded or filtered from the inter-organization messages.

In general, inter-organization messages may provide information about the event such as: who, what, where, when, and/or how. For example, the inter-organization messages may include requests to collect specific information or responses from receiving organization, such as: readiness status for a flood warning, the ability to provide sandbags, and/or the ability to provide medical assistance. Moreover, to facilitate tracking, threading (for easy navigation by recipients) and routing, a given inter-organization message may include: an identity (or identifier) of the originating organization, a geographic location of the affected area(s), a geographic location/boundary of the notified area(s), a geographic location of the originating organization, one or more geographic locations corresponding to an information item in the given inter-organization message, a timestamp of the given inter-organization message, an urgency or priority of the given inter-organization message, a type of the information item, and/or one or more recipient organizations.

Additionally, control mechanism 118 may (via interface mechanism 116) communicate the inter-organization messages with at least another organization in organizations 114 based on interrelationship information, where the other organization is different from the organization, and the interrelationship information specifies interrelationships among organizations 114. As described further below, the interrelationship information may be predefined in agreements between at least pairs of organizations 114. However, the interrelationship information may be adapted or changes, as needed, based on the needs associated with a particular type of event and/or based on revisions provided by organizations 114.

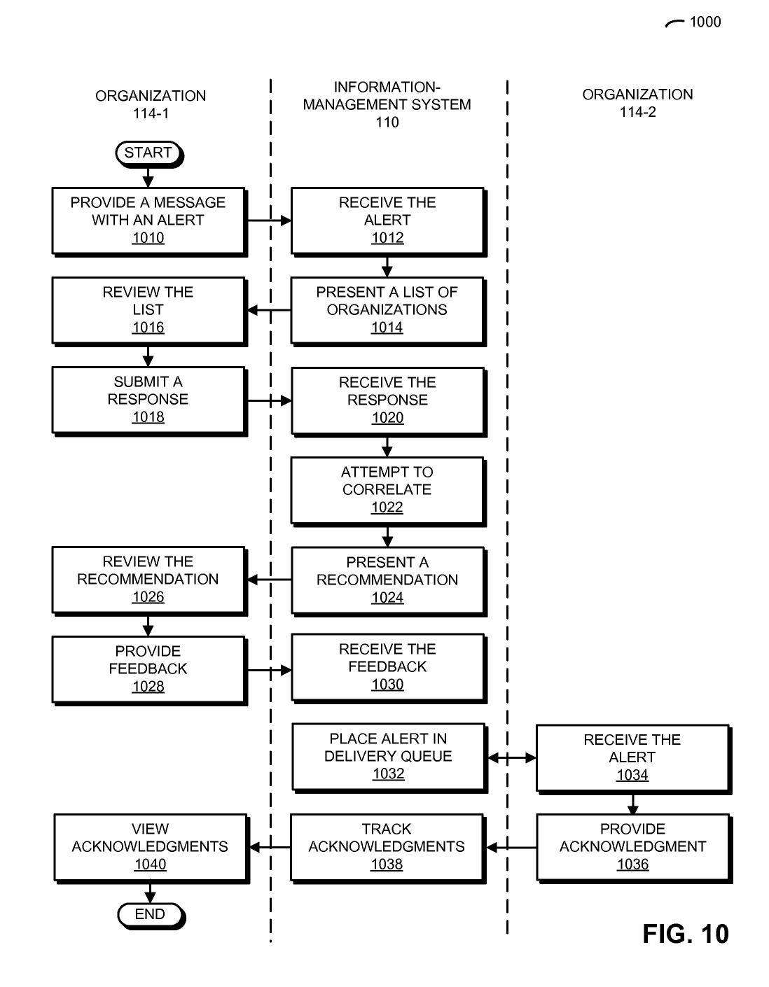

As described further below with reference to FIG. 10, in some embodiments the inter-organization messages are targeted messages or notifications. In particular, information-management system 110 sends the given inter-organization message to: one or more (designated) recipient organizations (which may be specified by the organization), to all of organizations 114, and/or to organizations meeting specific criteria (such as organizations in a particular region). For example, the inter-organization message may be sent to all organizations related to an airport or a municipality. Therefore, emergency managers at organizations 114 may send selected inter-organization messages (such as alerts) and can respond to specific requests to and from other emergency managers, in addition to the personnel in their organizations. Moreover, emergency managers receiving alerts from other organizations can act based on the incoming alert, including forward the information item in the alert to the personnel in their organizations if they deem it appropriate. This ability to send, receive and forward alerts among organizations 114 may be implemented in a manner that minimizes the potential impact on existing alerting systems used by organizations 114, including the effects on existing information-assurance or security certifications. As noted previously, information-management system 110 may allow organizations 114 to maintain full control and responsibility for privileged, confidential or sensitive information (such as PII) for their personnel, and the emergency managers at organizations 114 may retain control of when and how broadly an alert is disseminated to their personnel.

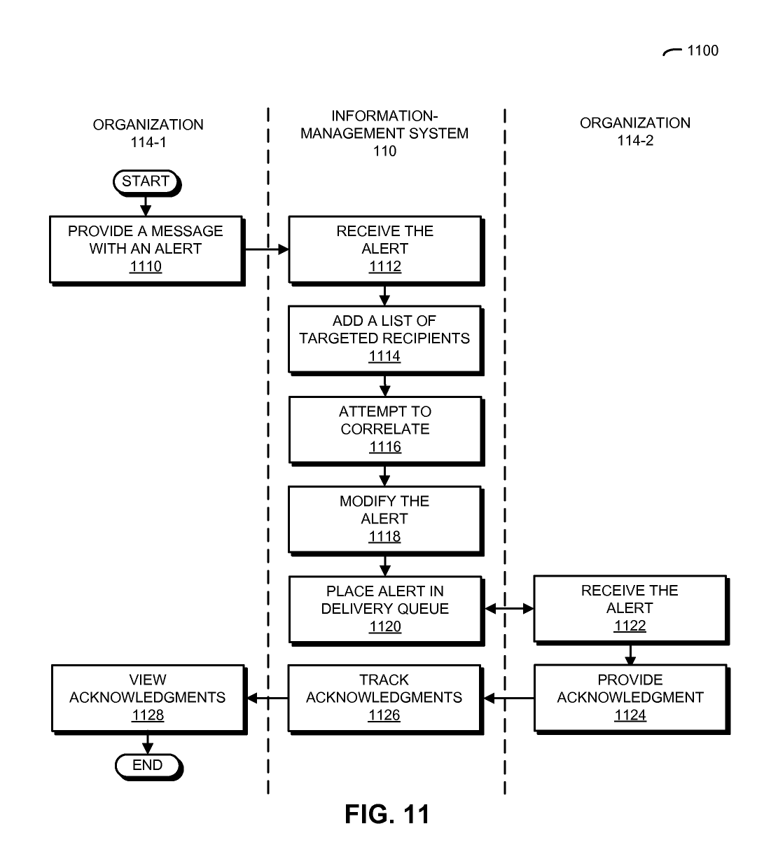

However, in other embodiments the inter-organization messages are published to organizations 114 based on their subscription to the service provided by information-management system 110. For example, as described further below with reference to FIG. 11, in some embodiments, information-management system 110 provides the ability to publish information to one or more data repositories which can be accessed by other organizations through subscription agreements. Information-management system 110 may provide information sources 112 and organizations 114 the ability to tag the information, either explicitly (e.g., by affected region, type, one or more topics, priority, etc.) or implicitly (e.g., based on the information source and/or the date and time of information). Information-management system 110 may also provide the ability to manage the subscriptions by an organization to data from information sources 112 that is of interest, as well as to publish updates to the organizations that have subscribed to a particular information source periodically or when an update is needed. Note that the subscriptions may be based on a variety of parameters, such as: the information source, keywords, categories, areas of interest, etc.

Alternatively or additionally, the inter-organization messages may be communicated based on collaborative channels between organizations 114. These collaborative channels may include: media (video feeds), chat rooms, maps, and/or may be ad-hoc or dynamic (e.g., based on the needs associated with the event or the type of event).

As noted previously, the communication between the organization and the one or more recipient organizations may be unidirectional or interactive (such as two-way communication or bi-directional communication), which may increase the speed, accuracy, and efficiency of the communications among organizations 114. Furthermore, the communicated information may include structured and/or non-structured (or free-form) information (such as predefined forms, queries and/or location-based information, as well as spoken or written responses). The use of structured information may allow information to be communicated among organizations 114 using a consistent data framework. For example, information-management system 110 may provide a data framework that enables consistent, scalable, rule- and form-based communication that supports predictable workflows, thereby reducing the likelihood of incorrect information being dispersed, and making operation of information-management system 110 faster, simpler and more intuitive for users, as compared with unstructured communications (such as used in many existing communication systems). Note that the structured information may include: form-based multimedia messages from agencies, predefined information to and from organizations 114, data originating from sensor systems (such as cybersecurity threat data, weather forecasts and warnings, etc.).

Information-management system 110 may track or confirm whether the given inter-organization message was received by the one or more recipient organizations. For example, information-management system 110 may generate follow-up one or more messages to confirm receipt of the given inter-organization message and/or may prompt users for additional information if the given inter-organization message was not received in a timely manner or if the message recipient was not fully responsive to prior communications. Thus, information-management system 110 may track delivery of the inter-organization messages, and may provide a notification when a delivery failure occurs.

Note that information-management system 110 may process the inter-organization messages in an order that is determined based on priorities associated with the inter-organization messages. Furthermore, information-management system 110 may communicate the inter-organization messages based on a hierarchy specified by the interrelationship information. For example, inter-organization messages may be communicated first to organizations that are proximate to the organization, and then may be communicated to organizations that are located further away. Alternatively, the inter-organization messages may be communicated first to a senior commander in the hierarchy or to organizations that are most likely to be affected by or at risk for the event. The hierarchy includes sub-hierarchies, such as groups of organizations in different countries. Thus, information-management system 110 may provide a scalable, geographically-distributed, federated information system serving multiple organizations or groups of organizations.

In some embodiments, the given inter-organization message includes redistribution information that defines or restricts whether the given inter-organization message may be redistributed to other organizations. For example, the redistribution information may be based on a location of the event, so that only organizations in proximity to the event or that are likely to be affected by the event may receive (directly from information-management system 110 or indirectly via one of organizations 114) the given inter-organization message.

Additionally, during the communication, control mechanism 118 may: receive a subsequent inter-organization message; analyze the subsequent inter-organization message; and add, to the subsequent inter-organization message, a link with a history of an associated thread in the inter-organization messages.

Information-management system 110 may provide the ability for information sources 112 and organizations 114 to share content, such as text, photographs, videos and common operating picture data among organizations 114. Updates to this content may be in near real-time and may be simultaneously available to participating organizations 114. Each of the participating organizations 114 may possess the appropriate display equipment to enable decision-makers to quickly evaluate and act upon the incoming data. Decisions and instructions from a unified-command center and/or operations-center personnel at organizations 114 may be distributed by information-management system 110 to relevant organization(s) with acknowledgement(s) from the tasked organization relayed back to the tasking or originating organizations.

In some embodiments, information-management system 110 facilitates the reliable and secure exchange of information among at least a subset of organizations 114 that participate in the management of an incident or event, enabling each of these organizations 114 to securely operate behind their respective firewalls and on their private networks (within which only their own authorized individual users or personnel may operate). While information-management system 110 may not provide tools for managing the crisis itself, it may enable organizations 114 to manage events via reliable, secure, and interactive exchange of information with relevant organizations and individuals related to these organizations.

Thus, information-management system 110 may provide continuous, real-time, interactive, traceable, threaded, organized and secure communication among organizations 114 using one of a variety of communication protocols.

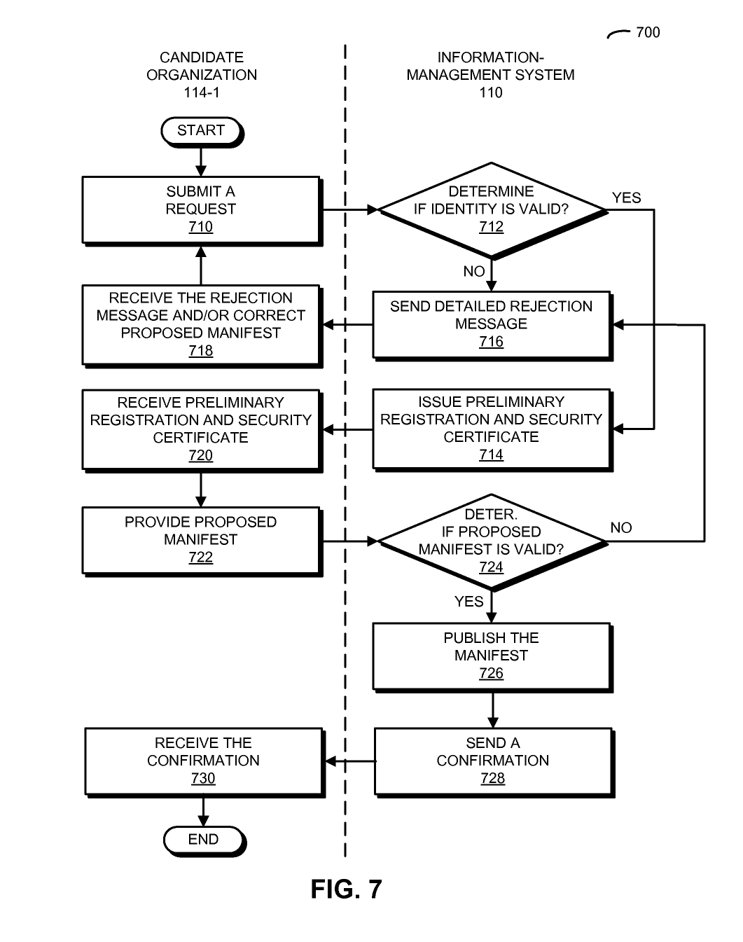

In addition to managing the communication, information-management system 110 may provide one or more additional services. For example, control mechanism 118 may invite and then register a new organization that is different from organizations 114. During registration, control mechanism 118 may validate the new organization and may provide authentication information (such as digital certificates/credentials) that may be used during subsequent communication of inter-organization messages. Moreover, during or after the registration, control mechanism 118 may: determine the information-sharing rules for the new organization based on characteristics associated with the new organization (and, in particular, a manifest of the new organization, which is described further below with reference to FIG. 7); and/or receive the information-sharing rules from the new organization. Furthermore, during or after the registration, control mechanism 118 may create agreements specifying the information-sharing rules among pairwise combinations of the new organization and organizations 114 based on the characteristics of the new organization and characteristics of organizations 114. For example, the characteristics may include types of organizations or other metadata associated with organizations 114 (such as what the organizations do, where they are located, etc.), so that related organizations can be identified and, as described further below, their interrelationships in the hierarchy may be determined. Alternatively or additionally, organizations 114 may negotiate or define the agreements, and then may provide the final agreements to information-management system 110.

In general, the agreements among organizations 114 are either explicit or implicit. Information-management system 110 may establish and maintain the agreements (such as business rules and/or interrelationship information) for information routing between any two of organizations 114, as well as to define how the information is shared (i.e., the information-sharing rules). Note that the agreements may or may not be reciprocal (e.g., the information-sharing rules may be different from organization A to organization B than from organization B to organization A). The agreements may specify the actions information recipients should take in response to receiving an inter-organization message with an information item from another organization including: whether to forward the information to another organization, and which reports to provide to the originating organization regarding the actions taken in response to the inter-organization message. Moreover, the agreements established between organizations 114 may also specify techniques to be employed or used to safeguard the information shared between organizations 114, including common information-assurance standards and the protocols to be used (such as an encryption technique).

Thus, there may be a variety of types of agreements (which define or specify interrelations and privileges/roles), and these agreements may be generated in a variety of ways. For example, there may be a direct agreement between two or organizations 114. This agreement may specify direction (i.e., send inter-organization messages and/or receive inter-organization messages), and may indicate a status of the agreement (such as invited, accepted, declines or disconnect/discontinue an existing interrelationship). Alternatively, an agreement may include a subscribe agreement to indicate that an organization subscribed to information published by at least one of information sources 112 and/or organizations 114. In some embodiments, an agreement may specify a group of organizations (which is sometimes referred to as a ‘community of interest’), which may include at least one of the organization in the group that are designated as a controller or administrator. The controller or administrator may approve membership in the group, and the resulting agreement may specify the type of interrelationship with the group (such as whether a particular organization sends inter-organization messages and/or receives inter-organization messages, where inter-organization messages are sent, whether moderation is needed, etc.).

In some embodiments, some of the communication conveyed by information-management system 110 does not require an agreement. For example, communication with a social network in information sources 112.

Additionally, control mechanism 118 may discover an additional organization based on the agreements and the characteristics, and may recommend the additional organization to the new organization for inclusion in organizations 114 (i.e., control mechanism 118 may facilitate discovery of organizations that could potentially benefit from certain types of information if an event occurs). For example, control mechanism 118 may identify a directory that allows organization A to lookup organization B based on country or location, a keyword, etc. Then, organization A may, via information-management system 110, send an invitation to organization B. When an operator associated with organization B receives the invitation, the operator may approve or decline the invitation. In the operator approves the invitation, information-management system 110 may create a connection or interrelationship information, and may update an operator of organization A. Alternatively, one of organizations 114 may, via information-management system 110, invite a non-network organization (i.e., an organization outside of organizations 114) to join. If the non-network organization accepts the invitation, information-management system 110 may register the non-network organization. Furthermore, organizations may, via information-management system 110, identify a group that they want to join. For example, organization B may identify a group managed by organization C and may, via information-management system 110, send a request to organization B. In response, organization B may accept or decline the request. Alternatively, organization B may, via information-management system 110, identify and invite organization C to join the group.

While the interrelationship information may be provided by the new organization and/or the organizations 114 during the registration process, in some embodiments control mechanism 118 determines, at least in part, the interrelationship information based on: communication among organizations 114 (such as emails); analysis of characteristics of organizations 114; and/or feedback about candidate interrelationship information received from organizations 114 (i.e., control mechanism 118 may provide candidate interrelationship information to an organization for its approval or modification). Thus, in some embodiments, an organization may accept or decline interrelationships (such as only allowing invitations from certain sectors or regions), and/or may instruct information-management system 110 to disconnect or stop communication in at least one direction in an interrelationship. Alternatively, information-management system 110 may automatically generate or determine the interrelationship information without approval from the organizations 114. This may involve using: default information-sharing rules; and/or determining the information-sharing rules (e.g., based on characteristics of the new organization and/or organizations 114). Note that information-management system 110 may store the interrelationship information in a data structure in a computer-readable memory, and at least some of the interrelationship information may be publically accessible or hidden.

In some embodiments, the interrelationship information specifies an ad-hoc or dynamic interrelationship. In particular, before or during the event, control mechanism 118 may: identify a new organization to add to organizations 114 based on a type of the event and/or a type of the new organization; and specify the information-sharing rules for the new organization. Note that specifying the information-sharing rules may involve: using default information-sharing rules; determining the information-sharing rules (e.g., based on characteristics of the new organization and/or organizations 114); and/or providing recommended information-sharing rules to the new organization for approval. For example, a particular organization may dynamically join a group or a community of interest when an event occurs. Alternatively, information-management system 110 may identify organizations that are relevant to the resolution of an event or crisis (e.g., based on the type of organization, location, organizational capabilities, etc.), and may suggest (for approval by one or more of organizations 114) or may automatically define the interrelationship information. The duration of such an ad-hoc or dynamic interrelationship may be limited to the duration of a specific event or incident, or as determined by the organization managing the group.

Moreover, information-management system 110 may provide auditing after an event. For example, information-management system 110 may perform or may facilitate a post-mortem analysis of the communication during the event to guide remedial action or institutional learning for use in preparing for and/or planning for future events. Alternatively or additionally, the audits may summarize failed communication (such as messages that were not received or acknowledgments that were not received) during an event.

Note that the inter-organization messages may include duplication-avoidance features to prevent information loops among organizations 114 when the inter-organization messages are communicated among organizations 114. For example, the inter-organization messages may include watermarks with location and timestamps for each organization that handles the inter-organization messages in a communication chain so that a given inter-organization message does not return to or is not forwarded back to the originating organization (such as the source or intermediary recipient in the chain). In particular, information-management system 110 may use the watermarks to ensure that an organization does not receive the same inter-organization message twice. In some embodiments, information-management system 110 analyzes the inter-organization messages to determine if they include updates so that organizations 114 do not receive the same inter-organization message twice. Furthermore, in some embodiments information-management system 110 may ‘seal’ a message in a thread or conversation, so that the message cannot be forward to a particular organization (or, in some embodiments, to any of organizations 114).

Although we describe information-management system 110 shown in FIG. 1 as an example, in alternative embodiments, different numbers or types of electronic devices, computer systems and servers may be present. For example, some embodiments comprise more or fewer information sources 112 and/or organizations 114.

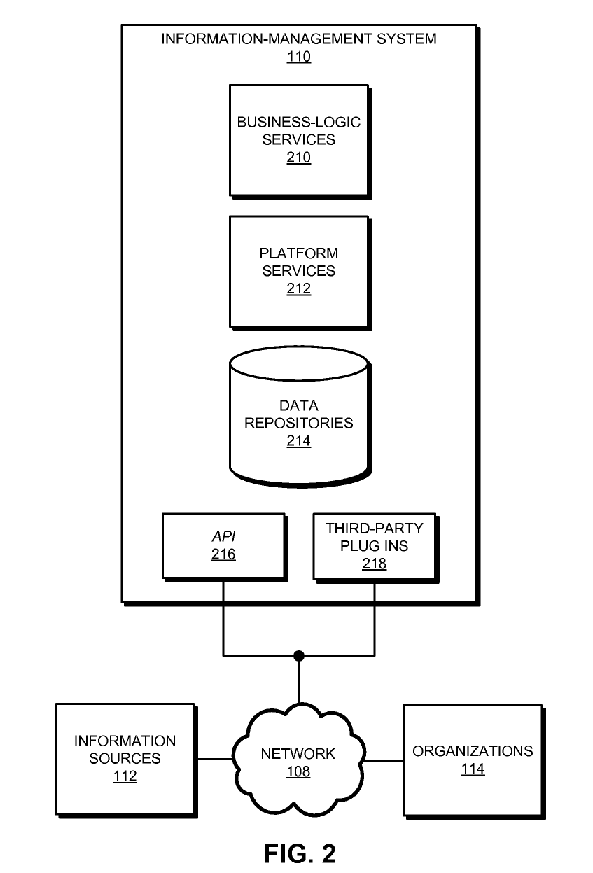

We now further describe embodiments of the information-management system. FIG. 2 presents a block diagram illustrating information-management system 110 (FIG. 1). In particular, information-management system 110 may include: one or more data repositories 214 (such as computer-readable data structures), platform services 212 and/or business-logic services 210. Information-management system 110 may also include interfaces for interacting with computer systems and electronic devices associated with information sources 112 and organizations 114, such as: an application programming interface (API) 216 and/or one or more third-party plug-ins 218. API 216 may provide a well-defined specification describing how organizations 114 interact with information-management system 110. Note that API 216 may be implemented using an information-management-system software subsystem that provides software operations, data structures, object classes, and variables in conformance with the API specification. Moreover, the one or more third-party plug-ins 218 may include implementations of various APIs associated with other systems that enable information-management system 110 to interact with these systems. For example, the systems for which one or more third-party plug-ins 218 are provided may include: at least some of information sources 112 (such as the National Weather Service) and/or organizational crisis-management systems associated with at least some of organizations 114 that do not implement API 216.

Furthermore, the one or more data repositories 214 may provide persistent storage and retrieval capabilities for the relevant computer systems and electronic devices at organizations 114. In some embodiments, the one or more data repositories 214 include at least one non-transitory computer-readable storage medium that stores data to facilitate effective operation of information-management system 110, such as: messages for delivery, system settings, applications for data processing and security, system logs, subscription information, etc.

Platform services 212 may be sub-divided into multiple categories of service, including: security services, communication services, and/or foundation services. In some embodiments, additional services that do not fit into one of these categories are provided. For example, the security services may protect the data security of the computer systems and electronic devices of organizations 114. The security services may include: authentication, authorization, encryption, and accounting services; single sign-on (SSO) services to the computer systems and/or electronic devices of organizations 114; protection services against malicious attempts to make information-management-system resources unavailable to their intended users (such as denial-of-service attacks); and/or content-security assessments. Moreover, the communication services may facilitate communication between information-management system 110 and the computer systems and electronic devices of organizations 114. In some embodiments, the communication services include: connections services that maintain persistent or long-lasting connections between information-management system 110 and the computer systems and electronic devices of organizations 114; Web services in which information-management system 110 receives, processes, and responds to requests from organizations 114 for resources; and/or Web services that provide a messaging framework for the exchange of structured crisis-related information between information-management system 110 and organizations 114 (i.e., the clients of information-management system 110). Furthermore, the foundation services may provide administrative services to various other subsystems within information-management system 110. In some embodiments, these services include: audit and logging services that record and provide documentary evidence of the sequence of activities that have affected a specific operation, procedure, or event; task-scheduling services that enable unattended scheduled execution of applications, scripts, and services; diagnostic services that provide tools for technical and status analysis when exceptions are trapped; workflow management services that provide orchestration of operational and technical task sequences; health-monitoring services that provide ongoing monitoring of operational and technical measures and that take preventive and corrective actions in case of deviations; high-availability services and disaster recovery software services that support computer clusters which can be reliably used with minimum down-time; and/or ongoing-system maintenance services (such as backup, restore, purging, and/or clean-ups).

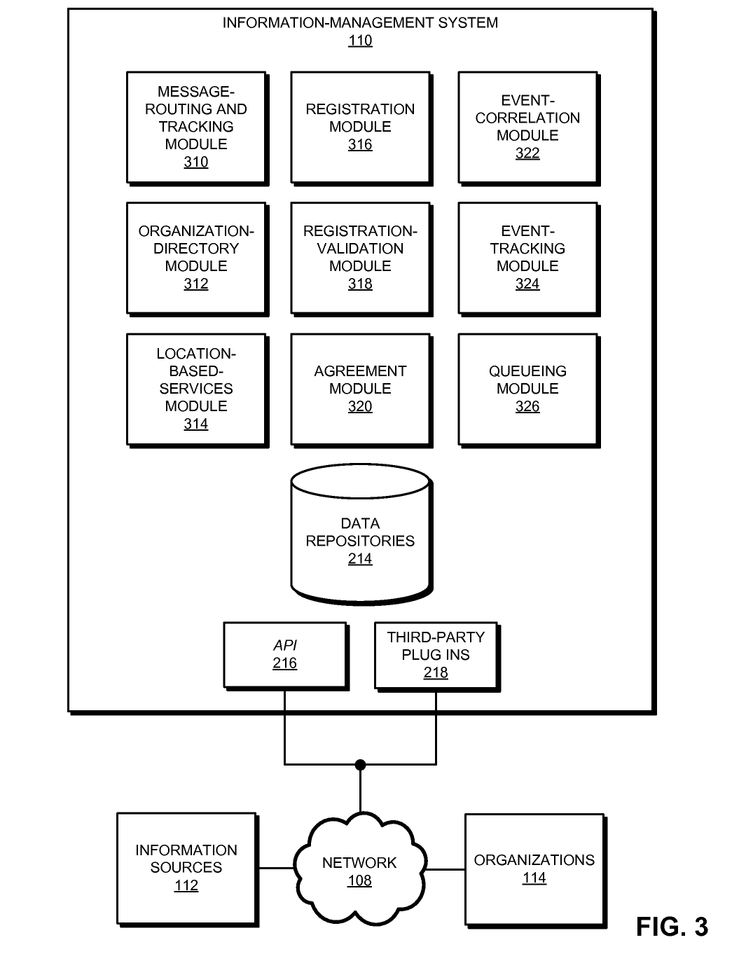

Business-logic services 210 provide the majority of the functionality described previously with reference to FIG. 1, such as managing registration, discovery, creating agreements, determining interrelationship information, generating inter-organizational messages, etc. The modules associated with business-logic services 210 are shown in FIG. 3, which presents a block diagram illustrating information-management system 110 (FIG. 1). In particular, as shown in FIG. 3, information-management system 110 may include: message-routing and tracking module 310; organization-directory module 312; location-based-services module 314; registration module 316; registration-validation module 318; agreement module 320; event-correlation module 322; event-tracking module 324; and/or queueing module 326.

Message-routing and tracking module 310 may process (including generalizing the non-sharable information) and route messages initiated by organizations 114 to their intended recipients or audiences. In some embodiments, the routing is based on the specific targeting information included in a given message and/or the agreements (if available) between organizations 114 with the originating organization. For example, if a specific audience is specified by the sender, then the given message may be routed to that audience. However, if the sender does not provide information regarding the target audience, the agreements for each of organizations 114 with the originating organization may be used to determine which organizations receive the given message. Moreover, message-routing and tracking module 310 may also: track receipt of the messages by their intended recipients, resend messages based on built-in business rules, and report on the success or failure of the communication (e.g., to the audit and logging services).

Organization-directory module 312, which may be supported by the one or more data repositories 214, may store, retrieve, modify and/or delete organization information associated with or related to organizations 114. The organization information may include attributes or characteristics of organizations 114, such as: names, addresses, locations, roles, business sectors, points of contact, privacy parameters for each attribute, communication parameters, whether or not an organization grants automatic permission to subscribe to alerts it issues, security parameters (such as digital certificates), and/or mechanisms and circumstances when to disconnect the computer systems and electronic devices of the organization from information-management system 110 community (such as in case of a security breach). In some embodiments, one or more data repositories 214 maintain a common structured taxonomy, such as: keywords, topics and/or other attributes that are used within messages communicated by information-management system 110 and among organizations 114.

Location-based services module 314 may provide geo-spatial functionality within information-management system 110. In some embodiments, the location-based services include: recommending agreements between at least two of organizations 114 based on their mutual location or proximity to each other; outbound-message distribution based on the locations of organizations 114; and/or applying location-based rules during inbound-message processing (such as restricting inbound messages based on the location of the originating organization of a given message).

Registration module 316 may enable organizations 114 to register for the services provided by information-management system 110. In some embodiments, registration module 316 provides services that: provide authentication, authorization, and account handling for organizations 114; enable organizations 114 to manage their communication and permission preferences (such as permissions of an organization to send and/or receive information to other organizations, communication policies of the organization, and/or the types of messages the organization is authorized to receive and process from the other organizations); and/or enable an organization to provide and update profile information of the other organizations.

Note that registration module 316 may be supported by registration-validation service 318, which may validate the identity, attributes and qualifications of a candidate organization prior to the completion of the registration process. In some embodiments, registration-validation service 316 uses a variety of external validation services (such as credit reports, manual verification of a member of organizations 114, etc.).

Agreement module 330 may manage the agreements between two or more organizations 114 or groups in organizations 114. As discussed previously, an agreement may define the mutual relationship between any two of organizations 114, such as describing the circumstances in which an organization will be sent messages from other organization. In particular, agreement module 330 manages the repository of agreements and the lifecycle of the agreements, including when an organization requesting to connect with another organization (e.g., an invitation to connect), and subsequent confirmation or declining of the request in whole or in part by the other organization. For example, an organization may ask for a bidirectional connection with another organization, but the other organization may only confirm a unidirectional connection. In some embodiments, agreement module 330 manages agreements between a group of organizations and its members (which is managed by the organization or organizations managing this group), including: inviting, approving, declining and/or modifying agreements with the organizations in the group. Furthermore, agreements module 330 may manage agreements that are time-bound or that are established in an ad-hoc fashion, which may allow agreements that are catered to a crisis situation, such as the response to a tornado.

Moreover, event-correlation module 322 may facilitate discovery of organizations to include in organizations 114 and/or in the interrelationship information for a particular organization. For example, event-correlation module 322 may identify an organization to include in the interrelationship information based on a particular event (such as a fire or a natural disaster) and the characteristics of the organization. As noted previously, the duration of such an ad-hoc or dynamic interrelationship may be limited to the duration of a specific event or incident. Furthermore, event-tracking module 324 may allow organizations 114 to organize and track different threads or conversations associated with one or more events. Event-tracking module 324 may also monitor duplication-avoidance features to prevent information loops among organizations 114 during communication in a thread associated with an event. Additionally, queueing module 326 may assist in the processing of messages. For example, queueing module 326 may handle incoming and outgoing messages based on priorities associated with or specified in the messages. Note that messages associated with certain events or organizations may be automatically treated as high priority. Alternatively or additionally, the priority of a given message may be defined by the originating organization and/or based on the interrelationship information (such as a relative position of the originating or destination organization in the hierarchy).

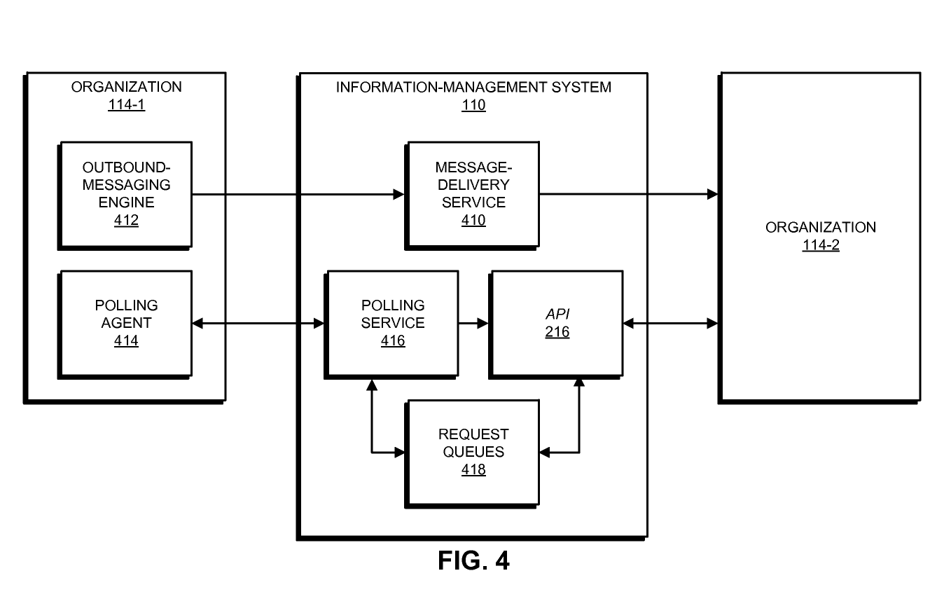

We now describe the flow of information between information-management system 110 and organizations 114. This is shown in FIG. 4, which presents a block diagram illustrating information-management system 110 (FIG. 1). Note that, for clarity, the flow of information associated with registration, establishing agreements and configuration information has been omitted from FIG. 4. During operation, information-management system 110 may deliver messages using message-delivery service 410 from one of organizations 114 to another and/or a request/response mechanism via polling service 416 and one or more request queues 418.

The direct delivery of messages may be initiated by an outbound-messaging engine 412 (or a module) in a representative organization in organizations 114 (such as organization 114-1). Outbound-messaging engine 412 may be compliant with the interface requirements of information-management system 110 (e.g., using API 216 and/or one of the one or more third-party plug-ins 218). When message-delivery service 410 receives the message originating from organization 114-1, it is processed and delivered to the targeted organization (such as organization 114-2). Note that messages may pass through a firewall of organizations 114 (if one exists) unimpeded as the messages are transmitted and received.

Alternatively, as noted previously, messages may be delivered based on a request/response mechanism. In particular, a request may be issued by organization 114-1 by polling agent 414 (or a module). This request may be compliant with the interface requirements of information-management system 110 (e.g., using API 216), and organization 114-1 may maintain an open connection with information-management system 110. Polling service 416 may forward the request to the one or more request queues 418, each of which may represent or be associated with a particular request priority (such as low priority, medium priority and high priority). Subsequently, when polling service 416 processes the request, it may determine whether the desired information is included in the one or more data repositories 214. If yes, polling service 416 may provide a response to polling agent 414. Alternatively or additionally, the request may be forwarded to organization 114-2 via API 216, and organization 114-2 may subsequently provide a response back to polling service 416. Then, polling service 416 may provide this response to polling agent 414. Furthermore, polling service 416 may also check whether any of the one or more request queues 418 has a message targeted to organization 114-1. If yes, polling service 416 may deliver the message using the open connection between information-management system 110 and organization 114-1.

In exemplary embodiments, uses cases for the information-management system include: cross-organization alerts based on targeted notifications (which is described further below with reference to FIG. 10); cross-organization information sharing using a publish/subscribe technique (which is described further below with reference to FIG. 11); and cross-organizational operational collaboration and coordination during incident response.

Cross-organization alerts based on targeted notifications typically occur when an organization becomes aware of a significant potential or actual threat, and wants to broadly share this time-sensitive information. In particular, messages about the threat may be sent to targeted recipients, and the sending or originating organization may determine the success or failure of the message delivery based on the positive acknowledgements that are subsequently received from the targeted recipients. For example, military installations may send alerts to tenant commands located within their installation. Alternatively or additionally, Federal agencies may send notifications to other Federal, state and local agencies located in a specific area (such as a municipality, a state, a region, etc.) about an identified threat. In some embodiments, an airport authority sends notifications to its tenants, such as: restaurants, airlines, service providers, local law enforcement, first-response agencies and/or Federal agencies (e.g., the Transportation Security Administration, U.S. Customs and Border Protection, U.S. Immigration and Customs, the Federal Aviation Administration, etc.).

In a variation on this use case, the targeted notifications may be in response to RFIs. In particular, an organization may initiate an RFI to one or more organizations that are likely to possess the requested information or a type of the requested information, and these organizations may then respond as described previously.

In existing communication techniques, cross-organization alerts based on targeted notifications typically are addressed using direct communication between the organizations by telephone or email. However, telephone communication is often restricted to a limited number of organizations with which the sender organization can simultaneously communicate, and the limited speed and accuracy of the communications. Similarly, email-based communication is often unable to effectively track message delivery and responses. In addition, is can be difficult to organize the information contained within the email messages in a useful manner, e.g., it may be difficult to implement threading or to avoid duplication or circuitous distribution of email messages. Note that telephone and email communication usually require: maintaining multiple directories of cross-organizational points of contact, sharing of confidential PH among the organizations, and/or maintaining cross-organizational information assurance certifications. Furthermore, by their nature, telephone and email communication are unstructured, which may result in communication delays and/or errors.

In contrast, the described information-management system may facilitate the cross-organization alerts based on the targeted notifications by allowing emergency managers to send selected alerts and to respond to specific requests to and from other emergency managers (as well as from personnel in their organization). Emergency managers that receive alerts from other organizations can respond to the incoming alert, e.g., by forwarding alerts to the personnel in their organization when and if they deem it appropriate. The capability to send, receive and forward alerts among organizations may be implemented in a manner that minimizes the potential impact on existing alert or communication systems used by the organizations, including the effects on existing information-assurance certifications. Note that the information-management system may structure the alerts so that they can be tracked, managed and organized. Furthermore, each organization may retain full control and responsibility regarding PH for the personnel in their organization and the emergency managers in a given organization may retain control of when and how broadly an alert is disseminated to their personnel.

As described further below with reference to FIG. 7, this use case may require the establishment of agreements between organizations to allow sharing of alerts between emergency managers, as well as specific guidelines within each organization regarding when to share alerts that are approved for sharing with other organizations. A given agreement may also specify what actions emergency managers should take in response to receipt of an alert from another organization, including when to forward that alert to additional personnel at the receiving organization and what reports to provide to the originating organization regarding the action taken. In some embodiments, the targeted alert includes embedded instructions and guidance regarding distribution and redistribution of the data, including designation of its sensitivity or priority. Note that the agreements established between pairs of organizations may also specify the techniques used to safeguard the alert information that is shared between organizations, including the common information assurance standards and protocols.

Cross-organization information sharing using an opt-in/opt-out publish/subscribe technique may occur when an organization compiles data of interest to another organizations and assumes the responsibility for publishing data that may be of interest to the other organizations. Alternatively or additionally, the organization may collect and assemble information from different sources (such as social media), and then may publish the processed information. Note that the information communicated using the publish/subscribe technique may include: weather updates, travel advisories, information about threats (such as cyber threats), etc. Often, the data being shared may be related to a designated geographic region or to a common topic, such as cyber security or terror threat-related warnings. Moreover, the data being shared may or may not be time-sensitive, but the need to share it may, in general, be broad in scope.

In this use case, responsibility for accessing and processing the data may reside with the subscribing organizations, and the publishing organization or agency typically does not require positive acknowledgement of receipt. Moreover, in this use case there typically is not an explicit contractual relationship between the publishing organization and the subscribing organizations. In contrast, it is often sufficient for a publishing organization to publish information pertaining to an area or a topic to which other organizations have subscribed. As noted previously, a special case of this capability is social media, in which one or more organizations may provide updates via one or more social networks, and may have the other organizations subscribe to these updates.

However, the published information is typically disseminated to the other organizations using email (based on email lists) and/or via the one or more social networks. Email-list management may incur a significant administrative overhead, such as requiring the maintenance of multiple directories of organizational points of contact and sharing confidential PII among the organizations. Furthermore, social media is usually open and unstructured, which can make it difficult for many organizations to leverage or effectively use. For example, it can be difficult to manage threading or to avoid duplication or circuitous distribution of messages containing the social media. Note that, by their nature, communication via email and social networks is usually unstructured, which is often insecure, and may lead to delays and errors unless a layer of information-assurance certifications is added.

These challenges can be addressed using the information-management system. In particular, the information-management system may allow emergency managers at each of the organizations to publish appropriate information (such as the sharable information and generalized information corresponding or related to the non-sharable information) to a repository that can be accessed by the other organizations through a subscription. Alternatively or additionally, at the time of publishing the information can be processed and disseminated to the other organizations in near-real-time based on a set of business rules. For example, the published information may be tagged, either explicitly (such as based on the affected region(s), type, topic(s), severity, etc.) or implicitly (such as based on the originating source, date and time of data item, etc.). In addition, the information-management system may facilitate and/or manage the subscriptions of a given organization in order to ensure that this organization can easily establish a subscription for data sources of interest, as well as periodically or as needed publish updates to the organizations that have subscribed to a particular data source. The subscriptions may be based on a variety of parameters, such as: source, keywords, categories, areas of interest, etc.

This use case may not require the establishment of agreements between organizations that are as strict as in the previous use case. For example, the agreements may simply acknowledge the terms of use of the data provided by the publishers. However, some of the agreements may be stricter, such as in classified environments or when exchanging sensitive information. In general, the agreements may outline the mutual responsibilities of each organization for the publication and consumption of various types of information and the various attributes contained within the published information, such as: urgency or priority, security classification or sensitivity, affected locations, etc.

Note that responsibility for published updates in the information-management system may be further specified based on a geographic region, such that particular organizations may be assigned specific areas of responsibility. This use case may also require processes for requesting (and subsequently approving) of a given organization subscribing to particular data sources, as well as the actions that may be required of an organization when it is notified of an update to a data source of interest. Moreover, the published information may also include embedded instructions and guidance regarding its intended audience and the distribution of the data, including a designation of its sensitivity. For example, a certain data source may be limited to Federal agencies only, or it may only be provided to approved organizations. Reciprocal agreements established between organizations using the information-management system may specify techniques to safeguard the information communicated between the organizations, such as common information-assurance standards and protocols to be used (such as an encryption technique).

During cross-organizational operational collaboration and coordination during incident response, organizational operations centers may exchange relevant information to provide status updates and support decision-making at the operational level by an authority structure in which the role of incident commander may be shared or jointly held by two or more individuals, each of whom may have authority in a different organization. This command structure is sometimes referred to as a unified command (UC). This use case often occurs during emergency response to significant events that require multiple organizations to adequately address needs, such as: security, fire and/or medical emergencies. Note that the exchanged data is typically time-sensitive, and the scope of the data exchange is usually determined by the number of organizations responding under the direction of the UC. While the type of information exchanged may vary, it typically includes large amounts of data that need to be displayed in a format that allows it to be readily understood and acted upon by decision makers. In order to enable effective collaboration, the information-management system may allow the participating organizations to access and view reports and simultaneously display a common operating picture (COP).

Existing approaches to addressing this use case are usually based on custom-developed systems, which are sometimes referred to as physical security integration management (PSIM) systems or common operating picture (COP) systems. However, these systems are typically expensive to acquire and operate, and therefore usually not widely deployed. Moreover, existing PSIM or COP systems are often incompatible with each other, so that exchanging information may be difficult. Therefore, commanders within a UC structure may have to resort to email, telephone and/or radio communication techniques, which can be inefficient, unreliable and error-prone. In particular, the use of radio communication, a common technique to achieve real-time response collaboration, often introduces interoperability challenges because the radio technologies, frequencies and standards may not be common across the organizations. Moreover, even when there are agreed frequencies and standards, radio communication is often limited to transient data, typically only conveys audio, and the number of active participants is usually restricted or limited.

These problems in this use case are addressed by the information-management system. In particular, the information-management system may facilitate the ability to rapidly share text, photo, video and geographical data from first responders to organization operations centers and UC posts, and vice versa. Consequently, updates may be near real-time and may be simultaneously available to the participating organization operations centers. In order to leverage these capabilities, the participating organizations may need to possess display equipment that allows decision-makers to quickly evaluate and act upon the incoming data. Then, decisions and direction from the UC and organization operations center personnel may be distributed to relevant personnel across the organizations with acknowledgement from the tasked organization(s) relayed back to the tasking organization.

Note that this use case may require the determination and specification of the types and frequency of data updates required by the UC and the participating organization operations centers for each potential incident type. For example, one data update requirement may be a list of critical information for the UC for specific incident types, which may help standardize the reporting and may minimize lower priority reports (especially during the initial response to an incident). Moreover, the UC structure among the participating organizations for the specific types of incidents may be specified by the interrelationship information. Furthermore, the responsibilities of the organizations may be specified in agreements created using the information-management system, such as in areas where the expertise of a given organization may be required to address a particular type of incident (e.g., assigning a lead agency to address chemical, biological and/or nuclear hazards present during incident response). In addition, the reciprocal agreements between the organizations may specify techniques to be used to safeguard information exchanged among the organizations, including common information-assurance standards and the protocols to be used (such as an encryption technique).

The information-management system addresses the needs of the organizations in these three use cases. In particular, the information-management system provides: constant and simultaneous updates of contact information at multiple organizations (which is typically impractical in existing communication systems based on email); facilitates the exchange of information without providing PH (which is typically difficult in existing communication systems based on email or telephone calls), and thus is compliant with organizational policies, laws and regulations; facilitates communication without requiring extensive and time-consuming coordination (e.g. by telephone); provides coverage over an arbitrarily large area (in contrast with existing communication systems based on radio communication); provides structured and bidirectional communication (in contrast with email or social media), which allows discussion threads or conversations related to incidents or events to be tracked; manages the communications based on business rules and agreements, such as who is authorized to send certain information and who is authorized to receive certain information (e.g., by telephone, email, social media, etc.); and maintains directories of organizations that can potentially benefit from certain types of information and provides the ability to discover such organizations (e.g., based on telephone calls, email, communications via the Integrated Public Alert and Warning System, social media, etc.).

In an exemplary embodiment, the information-management system includes a directory of organizations, each of which have associated metadata and information specifying how to connect to the organizations (e.g., behind a firewall in real-time without compromising security or a public system without a firewall). For example, the metadata may include: a role of an organization, a name or identifier of the organization, a sector, a location or region, a point of contact, and/or rule parameters (such as private or public, restrictions, whether connections need to be approved or not, etc.). In some embodiments, a digital certificate is used to identify the organization. In addition, the metadata may include a mechanism or information that specifies how to shutdown down a connection with the information-management system in case a breach is suspected.

Moreover, the information-management system may include agreements linking or defining the mutual relationships between the organizations, the rules governing their communications (such as the information-sharing rules) and the interrelationship information (such as who is connected to whom, whether the communication is unidirectional or bi-directional, what their roles are, etc.). In some embodiments, the communication is anonymous, so that a recipient organization does not know the identity of the originating organization.

The information-management system may allow member organizations to send invitations to connect to other organizations. These other organizations may be members of the information-management system and/or non-network organizations (i.e., outside of or not a current consumer of information processed by the information-management system). In the latter case, the invitation may instruct the recipient to join or subscribe to the service(s) offered by the information-management system and then to connect. In some cases, establishing a new connection may be moderated by third party (such as a community leader or organizer), which needs to approve the connection.

As noted previously, the data or information flow may be: targeted, published to a particular audience (which may be a restricted but audience, such as the defense department or the Federal government, but which may not be targeted) and/or open to all consumers of information processed by the information-management system. Moreover, the inter-organization messages may specify whether a response or acknowledgment is required or not. Furthermore, the inter-organization messages may include metadata, such as: an expiration date/time, a priority, a location, an event type, etc. Additionally, the inter-organization messages may include duplication-avoidance features to prevent information loops (i.e., cyclic or duplicate distribution) among the organizations during the communication associated with an event (such as during a particular thread). In this way, an originating organization, intermediary organizations and/or recipient organizations may not receive the same inter-organization message more than once.

In the information-management system, as messages are received (such as messages associated with events), the messages may be routed to the organizations, so that the organizations can take action and/or response to the originating organizations. For example, for targeted messages, a message with metadata indicating at least a designated target or recipient organizations may be received by the information-management system. Then, the information-management system may apply business rules specified in an agreement and interrelationship information so that non-sharable information is protected and the message is routed to at least the recipient organization. Next, the information-management system may collect responses from at least the recipient organization, and may issue a report to the originating organization.

Alternatively, during a ‘publish’ event flow, a publisher may provide a message and metadata. Then, the information-management system may apply business rules specified in one or more optional agreement and interrelationship information so that non-sharable information is protected and the message is routed to one or more consumers.

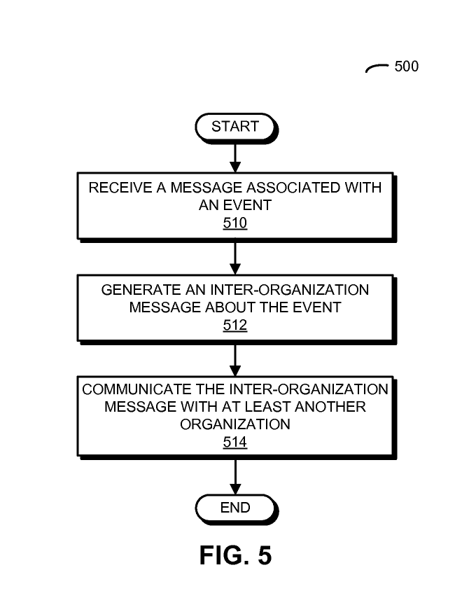

We now describe methods that may be performed using the information-management system. FIG. 5 presents a flow diagram illustrating a method 500 for communicating an inter-organization message among organizations that are enrolled in a service provided by an information-management system, such as information-management system 110 (FIGS. 1-4). During operation, the information-management system receives, from an information system and/or an information source, a message associated with an event (operation 510). Note that the event may or may not have already occurred. For example, the message may include a warning or a risk of a subsequent occurrence of the event, such as weather alert or a traffic alert. In general, the message may include information associated with the event as well as related metadata.

Then, the information-management system generates an inter-organization message about the event (operation 512) based on information-sharing rules of at least an organization in the organizations that specify sharable information across the organizations and non-sharable information across the organizations, where the inter-organization messages include the sharable information and generalized information corresponding to the non-sharable information to control distribution across the organizations of information about: the organization, members of the organization, and/or the event. Next, the information-management system communicates the inter-organization message with at least another organization (operation 514) in the organizations based on interrelationship information, where the other organization is different from the organization, and the interrelationship information specifies interrelationships among the organizations.

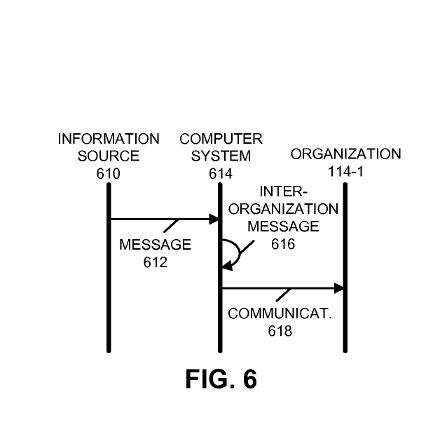

The communication technique is further illustrated in FIG. 6, which presents a drawing illustrating communication in an information-management system, such as information-management system 110 (FIGS. 1-4). In particular, information source 610 or organization 114-1 may provide message 612 associated with the event to computer system 614 in the information-management system. Then, computer system 614 generates inter-organization message 616 about the event based on the information-sharing rules. Next, computer system 614 communicates 618 inter-organization message 616 with at least organization 114-1.

FIG. 7 presents a flow diagram illustrating a method 700 for registering an organization in an information-management system, such as information-management system 110 (FIGS. 1-4). During this method, a candidate organization 114-1 may submit a request (operation 710) to register with and join a community or network of organizations associated with information-management system 110. Note that candidate organization 114-1 may provide the information requested by information-management system 110 during the registration process, including: general information about candidate organization 114-1 (e.g., a name or identifier, an address, a type of organization, a credit-rating-agency number, etc.), points of contact information (e.g., names, telephone numbers, roles within the organization, email addresses, etc.), referral information (such as one or more other members of the community who referred candidate organization 114-1) and/or location information (such as one or more locations where candidate organization 114-1 is located).

Then, information-management system 110 may determine if an identity of candidate organization 114-1 is valid (operation 712) using a third-party directory (e.g., a directory associated with a credit-rating agency) and/or by manually corroborating the information provided by candidate organization 114-1 with other sources (such as information provided by an organization that referred candidate organization 114-1). In some embodiments, validation (operation 712) involves vetting by a third party or another organization. The third party may determine and provide a reputation score for candidate organization 114-1, which may be compared to a threshold value to determine if candidate organization 114-1 is acceptable. Moreover, the third party may determine and provide the types, classification, sensitivity and/or other attributes of the information the candidate organization 114-1 may send or receive in the inter-organization messages. After successful validation (operation 712), information-management system 110 may issue a preliminary registration and a security certificate (operation 714), so that candidate organization 114-1 can complete the registration process in a safe manner. Otherwise, if the identity of candidate organization 114-1 was not validated (operation 712), a detailed rejection message may be sent (operation 716) to candidate organization 114-1, which subsequently receives the rejection message (operation 718).

After receiving the preliminary registration approval and the security certificate (operation 720), the operator of candidate organization 114-1 may submit or provide a proposed manifest (operation 722) to information-management system 110 for approval. This proposed manifest may contain information about candidate organization 114-1, such as: types of information candidate organization 114-1 is interested in, types of information it can provide, areas or locations of interest, data publishing and subscription policies (e.g., receive only, send only, send and receive, and conditions associated with such policies), policies regarding joining ad-hoc groups in cases of emergency (e.g., when a UC structure is mandated by an appropriate authority), and/or whether or not candidate organization 114-1 grants automatic approvals for requests for a mutual information-exchange agreement with another organization that subscribes to information-management system 110. Note that the proposed manifest may also include information about how alert messages are to be disseminated to organization 114-1. For example, the proposed manifest may state that information-management system 110 may push alert messages directly to candidate organization 114-1. Alternatively, the proposed manifest may state that candidate organization 114-1 may pull the alert message from one or more message queues in information-management system 110.

Next, information-management system 110 may determine if the proposed manifest is valid (operation 724) using business rules embedded in a registration-validation module in information-management system 110. After validation (operation 724), information-management system 110 may publish (operation 726) the approved organizational manifest to an organization-directory module in information-management system 110, and may sends a confirmation (operation 728) to candidate organization 114-1, which is subsequently received (operation 730). Alternatively, if the proposed manifest is not valid (operation 724), a detailed rejection message may be sent (operation 716) to candidate organization 114-1, candidate organization 114-1 may correct the proposed manifest (operation 718), and a revised request (operation 710) may be submitted to information-management system 110. This sub-loop or flow may be repeated until the proposed manifest is valid (operation 724). In an alternate embodiment (which is not depicted in FIG. 7), after providing the detailed rejection message (operation 716) to candidate organization 114-1, candidate organization 114-1 is allowed to update and correct the manifest (operation 722).

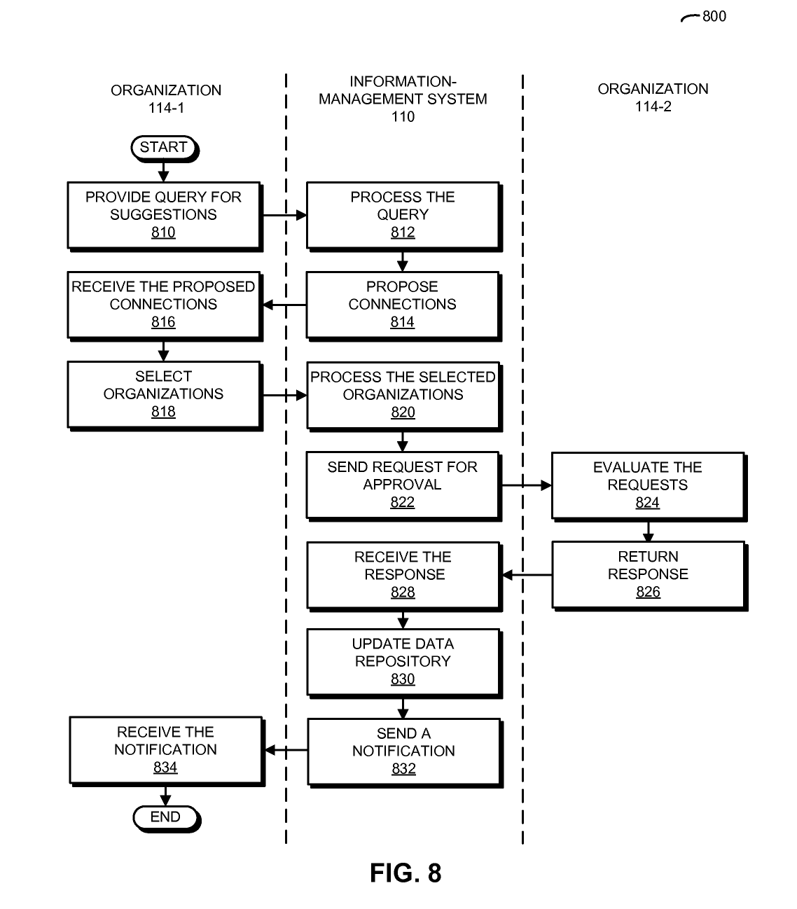

FIG. 8 presents a flow diagram illustrating a method 800 for establishing cross-organization agreements in an information-management system, such as information-management system 110 (FIGS. 1-4). After an organization is registered with information-management system 110, it may establish agreements with other organizations for the exchange of safety-related information with other organizations. Note that the agreements may include a set of business rules defining the information exchanged between any two members of a community or network of organizations that subscribe to information-management system 110. For example, a business rule may define if a certain message is sent from one organization to another based on whether: the receiving organization agrees to receive information from the sending or originating organization, the sending organization agrees to send information to the receiving organization, the locations of the two organizations, the type of information, the sensitivity of the information, the security classification of the information and/or other attributes of the organizations and the information.

As shown in FIG. 8, an operator of organization 114-1 may provide a query (operation 810) to information-management system 110 for suggestions for potential new connections with other organizations. In particular, during interaction with information-management system 110, the operator may specify what organizations they are is interested in including, such as: the types of organizations from which they are seeking information (e.g., a sheriff's department is seeking information from the regional Federal Bureau of Investigation office and the local county administration), and/or the general areas of events (e.g., a sheriff's department seeks information within its county of jurisdictions and neighboring counties).

Then, an organization-directory module in information-management system 110 may process the query (operation 812). In particular, in conjunction with a registration module in information-management system 110, organization-directory module may use business rules to return a list of candidate organizations with which organization 114-1 may establish agreements. Note that information-management system 110 may propose connections (operation 814) based on similar templates or other attributes of the organizations. The proposed connections may also include rationales and may indicate which of the proposed organizations have authorized information-management system 110 to automatically approve requests of type proposed, thereby bypassing manual approval (operation 818).

Moreover, after receiving the proposed connections (operation 816), an operator of organization 114-1 may select (operation 818), from the list of organizations provided by information-management system 110, those organizations with which agreements are desired. Note that the operator may, in response to a prompt by information-management system 110, establish filters with the organizations with which agreements are sought in order to further narrow the information provided by both organizations. These filters may include: the type of information, specific locations of events, severities of events, etc. The operator may also specify whether or not organization 114-1 is willing to send information to the other organization(s). Note that information-management system 110 may provide templates and mechanisms for supporting the establishment and updating of the agreements.

Furthermore, an agreement module in information-management system 110 may process the selected organizations (operation 820) received from organization 114-1. During this processing, the agreement module may confirm, for each organization with which an agreement is sought, whether the organization authorizes the information exchanges proposed by organization 114-1. For example, the agreement module may validate that organization 114-1 is committed, by its manifest, to engage in the proposed information exchange. Information-management system 110 may: return to organization 114-1 a list of approved agreements with those organizations that have delegated to information-management system 110, by manifest, the authority to automatically approve agreements; notify these organizations that agreements were established; and update the appropriate data repository in information-management system 110. Note that information-management system 110 may also return to organization 114-1 a list of agreements pending further approval. For each request for an agreement that requires further approval, the agreement module may track the response to the request and may remind both the submitting and receiving organizations that a pending agreement request is still active and that a response was not received in a timely manner.

Additionally, information-management system 110 may send requests for approval (operation 822) of agreements to each organization with which an agreement is sought but is not automatically approved by information-management system 110 (such as organization 114-2). These requests for manual approval are evaluated (operation 824) by authorized personnel at organization 114-2, and their response is returned (operation 826) to information-management system 110. After receiving such a response (operation 828), information-management system 110 may forward it to organization 114-1 and may update (operation 830) the appropriate data repository.

Subsequently, information-management system 110 may provide (operation 832) and organization 114-1 may receive a notification (operation 834) indicating whether a proposed agreement has been established or rejected. The notification may have a format that is compatible with or conforms to the API of information-management system 110. Note that organizations that conform to the API may directly consume such notifications and update their data repositories. Other organizations may update their data repositories manually.

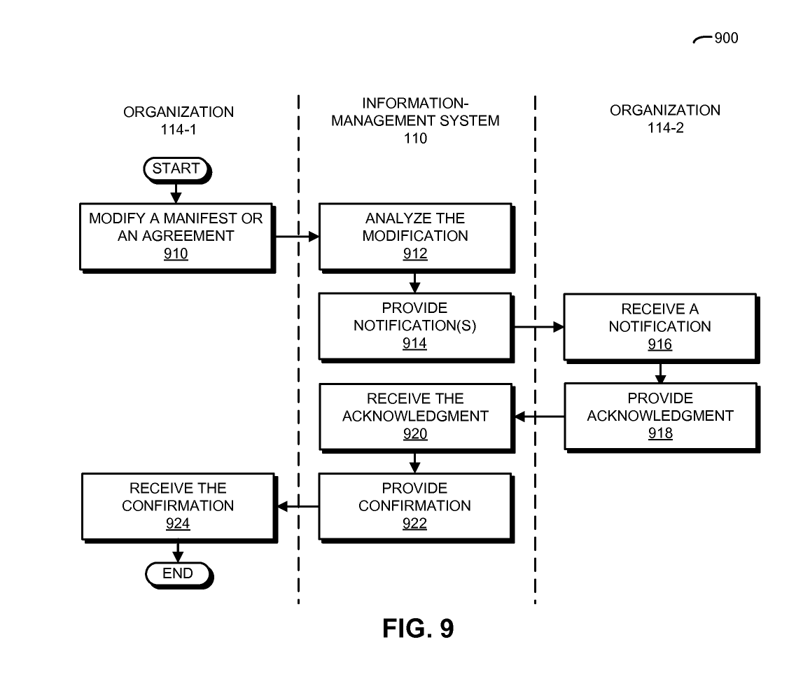

FIG. 9 presents a flow diagram illustrating a method 900 for modifying or cancelling cross-organization agreements in an information-management system, such as information-management system 110 (FIGS. 1-4). After organization 114-1 has registered with information-management system 110 and has established agreements with other organization, it may modify or cancel the registration and/or the agreements at any time. As shown in FIG. 9, an operator at organization 114-1 may modify, edit or cancel (operation 910) a manifest of organization 114-1 and/or specific (inter-organization) agreements.

Then, the agreement module and the registration modules may analyze the modification (operation 912) and may determine how the agreements of organization 114-1 with other organizations are affected. Moreover, a routing module in information-management system 110 may notify (operation 914) organizations affected by the modifications. These notifications may be sent in formats conforming to the API.

A recipient organization (such as organization 114-2) that receives a notification about a modification or cancellation of an agreement (operation 916) may respond based on its internal procedures (e.g., organization 114-2 may remove organization 114-1 from its targeted notification repository) and may acknowledge the notification (operation 918).

After receiving the acknowledgment (operation 920), information-management system 110 may confirm (operation 922) to organization 114-1 that the change has been received and acknowledged. Furthermore, organization 114-1 may receive the confirmation (operation 924).

FIG. 10 presents a flow diagram illustrating a method 1000 for communicating targeted notifications in an information-management system, such as information-management system 110 (FIGS. 1-4). An operator at organization 114-1 may author or provide a message with an alert (operation 1010) using the API. In addition to the message content, the operator may specify various attributes of the alert including: the alert type, affected location(s), the severity of the event, whether a response or an acknowledgement to the message is required, and/or other information related to the alert and/or the associated event. The operator may query information-management system 110 to propose target organizations for the proposed alert.

After receiving the alert (operation 1012), the agreement module may present (operation 1014) to the operator a list of organizations that conform to the queries results based on business rules established at the time of creation of the inter-organization agreements. The operator may review (operation 1016) the proposed list, and may accept it or modify it before submitting a response (operation 1018) to information-management system 110.

Then, after the response is received (operation 1020), an event-correlation module in information-management system 110 may attempt to correlate (operation 1022) the content of the proposed alert with events already being tracked by information-management system 110 and stored in its data repository. For example, the event-correlation module may use business rules to determine whether the proposed alert has already been issued in a similar or identical form by another organization. Note that the event-correlation module may use other business rules in an attempt to correlate the content of the proposed alert with events that are already being tracked by information-management system 110 and stored in its data repository. If a correlation is established, information-management system 110 may modify the proposed alert so that links to the correlated events are provided within the proposed alert. However, if no duplication or correlation is detected, the alert may be approved by information-management system 110 for dissemination.

If duplication or correlation is detected, information-management system 110 may present the proposed alert to the operator along with a recommendation (operation 1024) to cancel the alert (if the alert is a duplicate of another alert) or a modification to the alert based on the links to related events. The operator may review the recommendation (operation 1026) and may provide feedback (operation 1028), such as instructions to cancel, edit or approve the alert for dissemination, as appropriate, which is subsequently received (operation 1030) by information-management system 110.

After receiving an approval for disseminating the alert, a queuing module in information-management system 110 may place the alert in a delivery queue (operation 1032) in information-management system 110. Note that the delivery queue may be included in a message-routing and tracking module in information-management system 110). The selected data queue may depend on the alert, the priority of the alert, and/or the severity of the event. The message-routing and tracking module may, depending on the messaging policy of a recipient organization in its associated manifest, also determine whether to push the alert to a recipient organization (such as organization 114-2) or to wait until the alert is pulled by the recipient organization.

After receiving the alert (operation 1034), organization 114-2 may acknowledge receipt (operation 1036) via the API. Note that such acknowledgments may be tracked by the message-routing and tracking module. Alerts for which a response is requested may be read and responded to by the recipient operator.

After disseminating the alert (whether by a push or a pull technique), the message-routing and tracking module may begin tracking (operation 1038) acknowledgements and, if necessary, tracking responses from the targeted recipients. The operator of organization 114-1 can view (operation 1040) alert acknowledgements and response reports on demand or, if specified in the manifest of organization 114-1, information-management system may provide the reports.

FIG. 11 presents a flow diagram illustrating a method 1100 for sharing information in an information-management system, such as information-management system 110 (FIGS. 1-4) using a publish/subscribe technique. An operator at an organization 114-1 may author or provide (operation 1110) an alert using the API. Alternatively, an information source may send an alert to information-management system 110 for further dissemination to members of the community or network of organizations associated with information-management system. Note that the massage that conveys the alert may include: the alert type (such as a warning, an advisory, a watch, etc.), affected location(s), a severity of the associated event, and/or whether a response is required.

Then, after receiving the alert (operation 1112), the agreement module may add (operation 1114), based on established agreements between organization 114-1 and other organizations, a list of targeted recipients to the alert.

Moreover, the event-correlation module may attempt to correlate (operation 1116) the content of the proposed alert with events already being tracked by information-management system 110 and stored in its data repository. For example, the event-correlation module may use business rules to determine whether the proposed alert has already been issued in a similar or identical form by another organization. Note that the event-correlation module may also use other business rules in an attempt to correlate the content of the proposed message with events already being tracked by information-management system 110 and stored in its data repository. If a correlation is established, information-management system 110 may optionally modify (operation 1118) the proposed alert so that links to the correlated events are provided within the proposed alert.

Furthermore, the queuing module may place the alert in a delivery queue (operation 1120) in information-management system 110. Note that the delivery queue may be part of the message-routing and tracking module. The selected data queue may depend on the alert, the priority of the alert, and/or the severity of the event. The message-routing and tracking module may, depending on the messaging policy of a recipient organization in its associated manifest, also determine whether to push the alert to a recipient organization (such as organization 114-2) or to wait until the alert is pulled by the recipient organization.

After receiving the alert (operation 1122), if organization 114-2 conforms to the API, organization 114-2 may optionally acknowledge (operation 1124) receipt of the alert. Additionally, after disseminating the alert (whether by a push or a pull technique), the message-routing and tracking module may track acknowledgments (operation 1126). The operator of organization 114-1 can view alert acknowledgements (operation 1128) on demand or, if specified in the manifest of organization 114-1, information-management system 110 may provide reports.

In an exemplary embodiment, at least some of the operations in one or more of the preceding method are performed by a program module that is executed in an environment (such as an operating system) by a processor or processing subsystem (which are sometimes referred to as a ‘control mechanism’) of one or more electronic devices and/or computer systems in the information-management system. Alternatively, at least some of the operations in one or more of the preceding methods may be performed by an interface circuit or a networking subsystem (which are sometimes referred to as an ‘interface mechanism’) in the one or more electronic devices and/or computer systems.

In some embodiments of the preceding methods, there may be additional or fewer operations. Moreover, the order of the operations may be changed, and/or two or more operations may be combined into a single operation.

In an exemplary embodiment, the information-management system includes a federation of information-management systems. For example, information-management system 110 may be installed, configured and operated over multiple locations and data centers (which may be associated with one or more commercial entities, governments, etc.). Alternatively or additionally, as shown in FIG. 1, information-management system may work in a federated manner with multiple information-management systems (such as information-management systems 120 and 122) to provide a resilient, scalable, highly available service to its participants. In some embodiments, information flow control is used to restrict the distribution of information between information-management systems to abide by geopolitical information-protection requirements. Moreover, when there is more than one computer system (such as multiple servers) in information-management system 110, load-balancing techniques may be applied to ensure that no single server is overwhelmed. Furthermore, the functionality attributed to a single computer system in this discussion may be distributed across multiple computer systems. For example, one server may handle delivery of messages to the organizations, while another server may handle requests from the organizations. Note that information-management system 110 may use multiple geographically separated computer systems to balance load and in order to better serve users.

Additionally, the geographically separated computer systems may have different system manifests and system agreements with other computer systems (in the same or different information-management systems). Note that a system manifest in information-management system 110 may include information about information-management system 110, such as: types of information that information-management system 110 may share, areas of interest, data publishing and subscription policies (e.g., receive only, send only, send and receive, and conditions associated with such policies), and/or whether or not information-management system 110 grants automatic approvals for requests for a mutual information exchange agreements with other information-management systems.

The system manifest may also include information about how alert messages are disseminated to the other information-management systems. Moreover, the system manifest may indicate that information-management system 110 may push messages directly into another information-management system. Alternatively, the system manifest may state that information-management system 110 may pull messages from one or more message queues of information-management system 110.

The system agreements between the information-management systems may include a set of business rules defining the information exchanged between any two information-management systems. For example, a business rule may define if a certain message is sent from one information-management system to another based on whether: the receiving information-management system agrees to receive information from the sending information-management system, the sending information-management system agrees to send information to the receiving information-management system, the locations of the two information-management systems, the type of information, the sensitivity of the information, the security classification of the information and/or other attributes of information-management system 110.

In some embodiments, the agreements among at least some of organizations 114 allow special rights or privileges during an emergency. For example, an organization may have an agreement with another organization that allows the other organization to remotely control resources within a perimeter of a region associated with the organization (i.e., the other organization can control the resources from outside of the perimeter). Thus, the other organization may be able to control telephones, computers, sirens, and/or a notification messaging system from another location in the information-management system than one or more locations associated with the organization. This capability may be useful if the organization looses the ability to control the resources by itself during an emergency (such as if the organization is no longer operational). Note that these rights or privileges may be specified in the agreement between the organization and the other organization. Moreover, in these embodiments, the interaction between the organization and the other organization does not, therefore, stop or terminate at the interface between the organization and the other organization in the information-management system.

Additionally, in some embodiments the information-management system is used to conduct real-world drills or testing of the emergency preparedness of the organizations, as well as the effectiveness of the agreements, the interrelationship information, etc. This testing may allow the planning and capabilities of the organizations to be adapted and improved based on multiple instances of the testing. For example, the testing may occur between APIs associated with computer systems for different organizations, and may simulate emergency scenarios based on goals and performance metrics specified by the organizations. The testing may be conducted multiple times, such as daily, weekly, monthly, etc., or as needed (such as based on the results of a previous testing instance). The feedback that is determined by the information-management system based on the testing may include remedial action for the organizations. The remedial action may include recommendations for changes to the agreements to allow the organizations to achieve the desired or target goals.

In addition, the feedback may include comparative information, such as which organizations have the best policies or procedures, which may encourage the organizations to adopt best practices.

Note that the information-management system may be able to identify rights-protected content that cannot be communicated over a network (such as copyrighted material or sensitive material associated with one or more of the organizations) and/or information that may not be modified by the information-management system or its users. The rights-protected content may be flagged, and may be removed from the inter-organization messages. Alternatively or additionally, the rights-protected content may be flagged, and may be communicated without modification when it is included in one or more of the inter-organization messages.

We now describe embodiments of a computer system and an electronic device in the information-management system. FIG. 12 presents a block diagram illustrating a computer system 1200 (or an electronic device) in information-management system 110 (FIGS. 1-4). This computer system includes processing subsystem 1210, memory subsystem 1212, and networking subsystem 1214. Processing subsystem 1210 includes one or more devices configured to perform computational operations. For example, processing subsystem 1210 can include one or more microprocessors, application-specific integrated circuits (ASICs), microcontrollers, programmable-logic devices, and/or one or more digital signal processors (DSPs).

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: one or more program modules or sets of instructions (such as program module 1222 or operating system 1224), which may be executed by processing subsystem 1210. Note that the one or more computer programs may constitute a computer-program mechanism. Moreover, instructions in the various modules in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in computer system 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by computer system 1200 as fast-access storage for often-used data, while the mass-storage device is used to store less frequently used data.

Networking subsystem 1214 includes one or more devices configured to couple to and communicate on a wired, optical and/or wireless network (i.e., to perform network operations), including: control logic 1216, an interface circuit 1218 and one or more optional antennas 1220. For example, networking subsystem 1214 can include a Bluetooth networking system, a cellular networking system (e.g., an 3G/4G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, computer system 1200 may use the mechanisms in networking subsystem 1214 for performing simple wireless communication between the electronic devices, e.g., transmitting advertising or beacon frames and/or scanning for advertising frames transmitted by other electronic devices.

Within computer system 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections between the subsystems.

In some embodiments, computer system 1200 includes a display subsystem 1226 for displaying information on a display, which may include a display driver and the display, such as a liquid-crystal display, a multi-touch touchscreen, etc.

Computer system 1200 can be (or can be included in) any electronic device with at least one network interface. For example, computer system 1200 can be (or can be included in): a desktop computer, a laptop computer, a server, a media player (such as an MP3 player), an appliance, a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, a sensor, a user-interface device and/or another electronic device.

Although specific components are used to describe computer system 1200, in alternative embodiments, different components and/or subsystems may be present in computer system 1200. For example, computer system 1200 may include one or more additional processing subsystems, memory subsystems, networking subsystems, and/or display subsystems. Additionally, one or more of the subsystems may not be present in computer system 1200. Moreover, in some embodiments, computer system 1200 may include one or more additional subsystems that are not shown in FIG. 12. For example, computer system 1200 can include, but is not limited to, a data collection subsystem, an audio and/or video subsystem, an alarm subsystem, a media processing subsystem, and/or an input/output (I/O) subsystem. Also, although separate subsystems are shown in FIG. 12, in some embodiments, some or all of a given subsystem or component can be integrated into one or more of the other subsystems or component(s) in computer system 1200. For example, in some embodiments program module 1222 is included in operating system 1224. In some embodiments, computer system 1200 is geographically distributed over multiple separate (and remote) locations.

Moreover, the circuits and components in computer system 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1214, such as a radio. Moreover, the integrated circuit may include hardware and/or software mechanisms that are used for transmitting wireless signals from computer system 1200 and receiving signals at computer system 1200 from other electronic devices. Aside from the mechanisms herein described, radios are generally known in the art and hence are not described in detail. In general, networking subsystem 1214 and/or the integrated circuit can include any number of radios. Note that the radios in multiple-radio embodiments function in a similar way to the described single-radio embodiments.

In some embodiments, networking subsystem 1214 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, etc.)

The described embodiments of the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program module 1222, operating system 1224 (such as a driver for interface circuit 1218) or in firmware in interface circuit 1218. Alternatively or additionally, at least some of the operations in the communication technique may be implemented in a physical layer, such as hardware in interface circuit 1218.

While the focus in the present discussion is on inter-organization communication, the information-management system may also be used for intra-organization communication. For example, individuals in an organization may be dynamically arranged into subgroups with different privileges (such as individuals with an event perimeter or who are at risk and other individuals who are outside the event perimeter or who are not at risk). Moreover, the information-management system may provide instructions, information, requests and/or a status-check request to the individuals in the organization (e.g., via intra-organization messages). This may allow the information-management system to use the individuals in the organization to dynamically collect information (e.g., the individuals and/or their associated electronic devices, such as cellular telephones, as ‘sensors’). Alternatively, electronic devices used by the organization that are not associated with individuals (such as fire alarms or cybersecurity detectors) may be used to collect data. Furthermore, while the preceding discussion has used emergencies or crisis as illustrations of events, in other embodiments the events may be related to healthcare. In these embodiments, the information-sharing rules may allow the organizations to exchange the inter-organization messages while complying with regulations, such as the Health Insurance Portability Accountability Act. Thus, the non-sharable information may specify protected health information, and the information-management system may facilitate the exchange of information between organizations without simply excluding the protected health information from the inter-organization messages. Instead, the protected health information may be de-identified and generalized in the inter-organization messages by the information-management system.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. An information-management system, comprising:
an interface mechanism that, during operation, communicates with information systems, information sources and electronic devices used by organizations, wherein the organizations are enrolled in a service provided by the information-management system;
a control mechanism, coupled to the interface mechanism, that, during operation:
receives, from at least one of the information systems and the information sources, a message associated with an event, the message including a location of the event and data associated with the event;
determines at least one organization in the organizations to receive an inter-organization message based on information sharing rules and the location;
generates the inter-organization message about the event based on the information-sharing rules of the at least an organization in the organizations that specify sharable information across the organizations and non-sharable information across the organizations, wherein the inter-organization message include the sharable information and generalized information that replaces and is less specific than the non-sharable information to control distribution across the organizations of information about at least one of: the organization, members of the organization, or the event, wherein the inter-organization message includes embedded instructions on redistribution of the data associated with the event; and
communicates, through a network, the inter-organization message with the at least one organization in organizations.

2. The information-management system of claim 1, wherein the event includes one of: an emergency, and a crisis situation.

3. The information-management system of claim 1, wherein the organizations include at least one of: first groups in an entity, second groups at geographic locations associated with the entity, state governments in the entity, local governments in the entity, government agencies, non-government organizations, commercial entities, and healthcare organizations.

4. The information-management system of claim 1, wherein the communication is bi-directional and includes structured and non-structured responses.

5. The information-management system of claim 1, wherein the inter-organization messages are processed in an order that is determined based on priorities associated with the inter-organization messages.

6. The information-management system of claim 1, wherein the non-sharable information is other than excluded from the inter-organization messages.

7. The information-management system of claim 1, wherein, during operation, the control mechanism registers a new organization that is different from the organizations; and
wherein, during the registration or after the registration, the control mechanism performs one of: determining the information-sharing rules for the new organization based on characteristics associated with the new organization;
and receiving the information-sharing rules from the new organization.

8. The information-management system of claim 7, wherein, during the registration or after the registration, the control mechanism creates agreements specifying the information-sharing rules among pairwise combinations of the new organization and the organizations based on the characteristics of the new organization and characteristics of the organizations.

9-15. (canceled)

16. The information-management system of claim 1, wherein the control mechanism comprises:
a processor coupled to the interface mechanism; and
a memory, coupled to the processor, which stores a program module that, during operation, is executed by the processor, the program module including instructions for at least some operations performed by the control mechanism.

17. A computer-program product for use in conjunction with an information management system, the computer-program product comprising a non-transitory computer-readable storage medium and a computer-program mechanism embedded therein to communicate an inter-organization message among organizations that are enrolled in a service provided by the information-management system, the computer-program mechanism including:
instructions for receiving, from at least one of the information systems and the information sources, a message associated with an event, the message including a location of the event and data associated with the event;
instructions for determining at least one organization in the organizations to receive an inter-organization message based on information sharing rules and the location;
instructions for generating the inter-organization message about the event based on the information-sharing rules of the at least an organization in the organizations that specify sharable information across the organizations and non-sharable information across the organizations, wherein the inter-organization messages include the sharable information and generalized information that replaces and is less specific than the non-sharable information to control distribution across the organizations of information about at least one of: the organization, members of the organization, or the event, wherein the inter-organization message includes embedded instructions on redistribution of the data associated with the event; and
instructions for communicating, through a network, the inter-organization message with the at least one organization in organizations.

18. The computer-program product of claim 17, wherein the computer program mechanism further comprises instructions for:
registering a new organization; and
during the registration or after the registration, one of: determining the information-sharing rules for the new organization based on characteristics associated with the new organization; and receiving the information-sharing rules from the new organization.

19. (canceled)

20. An information-management-system-implemented method for communicating an inter-organization message among organizations that are enrolled in a service provided by the information-management system, wherein the method comprises:
receiving, from at least one of an information system and an information source, a message associated with an event, the message including a location of the event and data associated with the event;
determining at least one organization in the organizations to receive an inter-organization message based on information sharing rules and the location;
using a control mechanism in the information-management system, generating the inter-organization message about the event based on the information-sharing rules of the at least an organization in the organizations that specify sharable information across the organizations and non-sharable information across the organizations, wherein the inter-organization message include the sharable information and generalized information that replaces and is less specific than the non-sharable information to control distribution across the organizations of information about at least one of: the organization, members of the organization, or the event, wherein the inter-organization message includes embedded instructions on redistribution of the data associated with the event; and
communicating, through a network, the inter-organization message with the at least one organization in organizations.
